(19) United States
(12) Patent Application Publication
(10) Pub. No.: US 2018/0045940 A1
(43) Pub. Date: Feb. 15, 2018

(54) MICROSCOPE AND OPTICAL UNIT

(71) Applicant: OLYMPUS CORPORATION, Tokyo (JP)

(72) Inventors: Shintaro KOBAYASHI, Tokyo (JP); Hironori UTSUGI, Tokyo (JP); Masayoshi KARASAWA, Tokyo (JP); Masaru KOBAYASHI, Tokyo (JP)

(73) Assignee: OLYMPUS CORPORATION, Tokyo (JP)

(21) Appl. No.: 15/673,384

(22) Filed: Aug. 9, 2017

(30) Foreign Application Priority Data
Aug. 10, 2016 (JP) 2016-157654
Jun. 8, 2017 (JP) 2017-113811

(51) Int. Cl. G02B 21/02; G02B 21/26; G02B 21/36; G02B 5/22; G02B 21/08; G02B 7/02; G02B 27/14

(52) U.S. Cl. CPC G02B 21/02; G02B 7/02; G02B 21/26; G02B 27/141; G02B 5/22; G02B 21/088; G02B 21/361

(57) ABSTRACT

A microscope includes: a main body having: a base portion; a pillar portion vertically disposed on part of an outer edge portion of the base portion; and an arm portion extending from an end of the pillar portion to face the base portion, an opposite end of the pillar portion connecting to the base portion; an objective lens support portion provided on one side of the arm portion facing the base portion and configured to hold an objective lens that is detachable from the objective lens support portion; an observation portion provided on an opposite side of the arm portion and configured to hold an eyepiece that is detachable from the observation portion; and an optical unit configured to hold an optical element. The arm portion includes a holding portion configured to hold the optical unit at a position intersecting with an optical axis of the objective lens.

### CROSS REFERENCES TO RELATED APPLICATIONS

This application is based upon and claims the benefit of priority from Japanese Patent Application No. 2016-157654, filed on Aug. 10, 2016 and Japanese Patent Application No. 2017-113811, filed on Jun. 8, 2017, the entire contents of which are incorporated herein by reference.

### BACKGROUND

### 1. Technical Field

The disclosure relates to an upright microscope and an optical unit for irradiating a specimen on a stage with illumination light to form an observation image.

### 2. Related Art

Upright microscopes have been used in various fields, such as a medical field and a biological field, for the purpose of research, examination, and education (e.g., refer to JP 2011-53324 A). In JP 2011-53324 A, an optical unit is disposed between an objective lens and a lens barrel using a buildup method. More specifically, by building up the optical unit on an arm portion that holds a revolver, the optical unit is disposed between the arm portion and the lens barrel. The optical unit is thereby disposed between the objective lens and the lens barrel, and an optical element having predetermined optical characteristics can be inserted onto an observation light path.

### SUMMARY

In some embodiments, a microscope includes: a main body having: a base portion; a pillar portion vertically disposed on part of an outer edge portion of the base portion; and an arm portion extending from an end of the pillar portion to face the base portion, an opposite end of the pillar portion connecting to the base portion; an objective lens support portion provided on one side of the arm portion facing the base portion, the objective lens support portion being configured to hold an objective lens that is detachable from the objective lens support portion; an observation portion provided on an opposite side of the arm portion and configured to hold an eyepiece that is detachable from the observation portion; and an optical unit configured to hold an optical element. The arm portion includes a holding portion configured to hold the optical unit and locate the optical unit at a position intersecting with an optical axis of the objective lens held by the objective lens support portion.

In some embodiments, an optical unit used for a microscope is provided. The microscope includes: a main body having: a base portion; a pillar portion vertically disposed on part of an outer edge portion of the base portion; and an arm portion extending from an end of the pillar portion to face the base portion, an opposite end of the pillar portion connecting to the base portion; an objective lens support portion provided on one side of the arm portion facing the base portion, the objective lens support portion being configured to hold an objective lens that is detachable from the objective lens support portion; and an observation portion provided on an opposite side of the arm portion and configured to hold an eyepiece that is detachable from the observation portion. The arm portion includes a holding portion configured to house the optical unit and locate the optical unit at a position intersecting with an optical axis of the objective lens held by the objective lens support portion. The optical unit includes an optical element configured to be inserted onto a light path passing through the optical axis of the objective lens held by the objective lens support portion.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a schematic configuration of a microscope according to a first embodiment of the present invention;

FIG. 2 is a diagram schematically illustrating a configuration of a main part of the microscope according to the first embodiment of the present invention;

FIG. 3 is a diagram schematically illustrating a configuration of a main part of the microscope according to the first embodiment of the present invention;

FIG. 4 is a perspective view schematically illustrating a configuration of an optical unit of the microscope according to the first embodiment of the present invention;

FIG. 5 is a diagram illustrating a configuration of a region R₁ illustrated in FIG. 1;

FIG. 6 is a diagram illustrating a configuration of a region R₂ illustrated in FIG. 5;

FIG. 7 is a schematic diagram illustrating a schematic configuration of the microscope according to the first embodiment of the present invention;

FIG. 8 is a diagram illustrating a configuration of a region R₃ illustrated in FIG. 7;

FIG. 9 is a schematic diagram illustrating a schematic configuration of a microscope according to a second embodiment of the present invention;

FIG. 10 is a diagram illustrating a configuration of a region R₄ illustrated in FIG. 9;

FIG. 11 is a schematic diagram illustrating a schematic configuration of a microscope according to a third embodiment of the present invention;

FIG. 12 is a diagram illustrating a configuration of a region R₅ illustrated in FIG. 11;

FIG. 13 is a schematic diagram illustrating a schematic configuration of a microscope according to a fourth embodiment of the present invention;

FIG. 14 is a diagram illustrating a configuration of a region R₆ illustrated in FIG. 13;

FIG. 15 is a schematic diagram illustrating a schematic configuration of a microscope according to a modified example of the fourth embodiment of the present invention;

FIG. 16 is a schematic diagram illustrating a schematic configuration of a microscope according to a fifth embodiment of the present invention;

FIG. 17 is a diagram illustrating a configuration of a region R₇ illustrated in FIG. 16;

FIG. 18 is a schematic diagram illustrating a configuration of a main part of a microscope according to a first modified example of the fifth embodiment of the present invention;

FIG. 19 is a schematic diagram illustrating a configuration of a main part of a microscope according to a second modified example of the fifth embodiment of the present invention;

FIG. 20 is a schematic diagram illustrating a configuration of a main part of a microscope according to a third modified example of the fifth embodiment of the present invention;

FIG. 21 is a schematic diagram illustrating a configuration of a main part of a microscope according to a fourth modified example of the fifth embodiment of the present invention;

FIG. 22 is a schematic diagram illustrating a schematic configuration of a microscope according to a sixth embodiment of the present invention;

FIG. 23 is a diagram illustrating a configuration of a region R₈ illustrated in FIG. 22; and

FIG. 24 is a schematic diagram illustrating a configuration of a main part of the microscope according to the sixth embodiment of the present invention.

### DETAILED DESCRIPTION

Exemplary embodiments of the present invention will be described in detail below with reference to the drawings. The present invention is not limited to the following embodiments. The drawings to be referred to in the following description only schematically illustrate shapes, sizes, and positional relationships to such a degree that the description of the present invention can be understood. In other words, the present invention is not limited to the shapes, sizes, and positional relationships that are exemplified in the drawings.

### First Embodiment

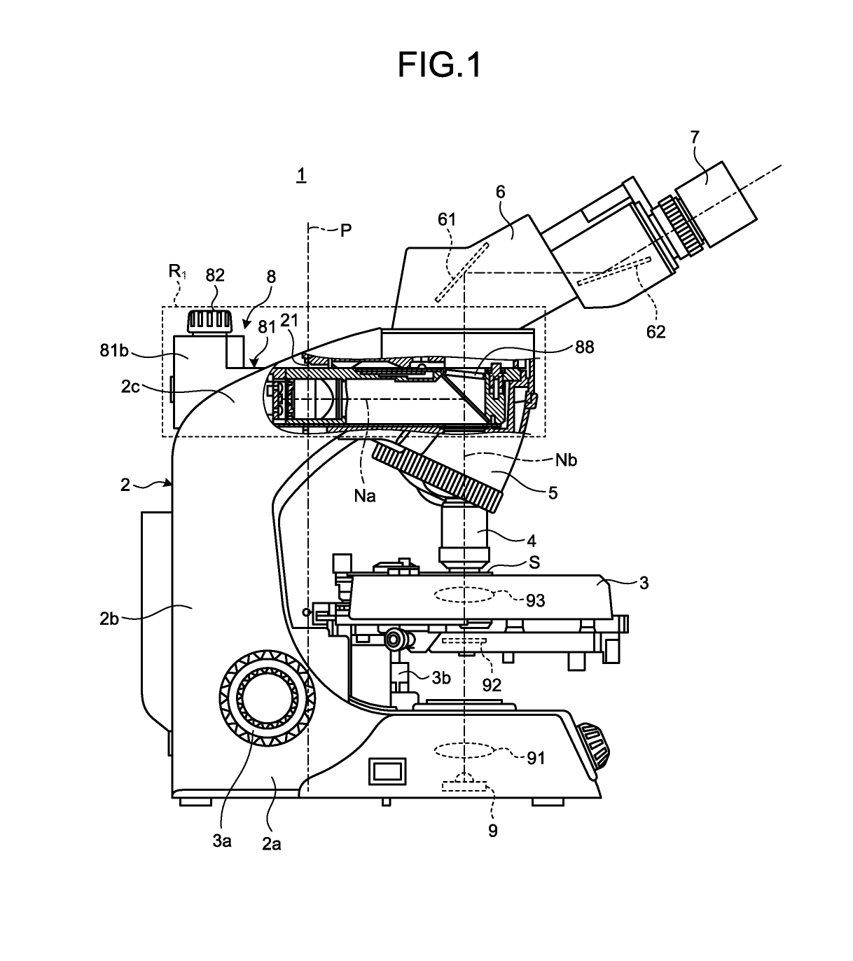

A microscope according to some embodiments of the present invention will be described with reference to the drawings. FIG. 1 is a schematic diagram illustrating a schematic configuration of a microscope according to a first embodiment of the present invention. As illustrated in FIG. 1, a microscope 1 is an upright microscope formed by a stage 3, an objective lens 4, an optical unit 8, and the like being attached to a main body 2. A front face of the microscope 1 faces a user in use. That is, the right side of FIG. 1 corresponds to the front face of the microscope 1, and the left side of FIG. 1 corresponds to a back side of the microscope 1. The microscope 1 illustrated in FIG. 1 illustrates a state in which an illumination light path Na of the optical unit 8 is disposed at a first position where the illumination light path Na connects to an observation light path Nb.

The main body 2 includes a base portion 2a, a pillar portion 2b, and an arm portion 2c. The base portion 2a is directly placed on a location where the microscope 1 is disposed, such as on a desk. The pillar portion 2b is vertically disposed on a rear side of the base portion 2a. The arm portion 2c extends from an upper end of the pillar portion 2b toward the front face of the microscope 1. The base portion 2a is provided with a control board (not illustrated) for controlling the entire microscope 1. The control board relays power supply from the outside to each unit, or has a built-in power source in itself and relays power supply to each unit.

The base portion 2a includes a light source 9 for emitting transmission illumination light, and a collector lens 91 for collecting illumination light. The light source 9 is realized by using, for example, a light emitting diode (LED) light source (solid-state light source), and lights up and goes out under the control of the control board. The LED light source is formed by using, for example, a monochroic LED and a fluorescent member, and emits white-color illumination light. The fluorescent member has a dome shape to which fluorescent material is applied, and covers the LED. In this configuration, the fluorescent member is excited by light emitted by the LED, to emit light.

The stage 3 on which a specimen S as an observation target is placed is provided on the front face of the pillar portion 2b. The stage 3 is supported on the pillar portion 2b via a focusing guide, and is movable along an optical axis of the objective lens 4 disposed on the observation light path Nb, by an operation of a focus handle 3a, for example. The focus handle 3a is configured to be rotatable, and using the rotation of itself, moves the stage 3 by a known method such as a gear and a rack-and-pinion. The stage 3 is movable on a plane vertical to the optical axis of the objective lens 4, by an operation handle 3b. The specimen S is held on a holding member such as, for example, a laboratory dish and a glass slide.

The stage 3 is provided with a brightness diaphragm 92 and a condenser lens 93. Illumination light emitted from the light source 9 is collected by the collector lens 91, and a numerical aperture is adjusted by the brightness diaphragm 92. After that, illumination light having passed through the brightness diaphragm 92 is collected by the condenser lens 93 to illuminate the specimen S. The collector lens 91, the brightness diaphragm 92, and the condenser lens 93 constitute an illumination optical system for performing critical illumination for the specimen S. At this time, the light source 9 and the specimen S, and an exit pupil of the objective lens 4 and the brightness diaphragm 92 are disposed at positions conjugated to each other.

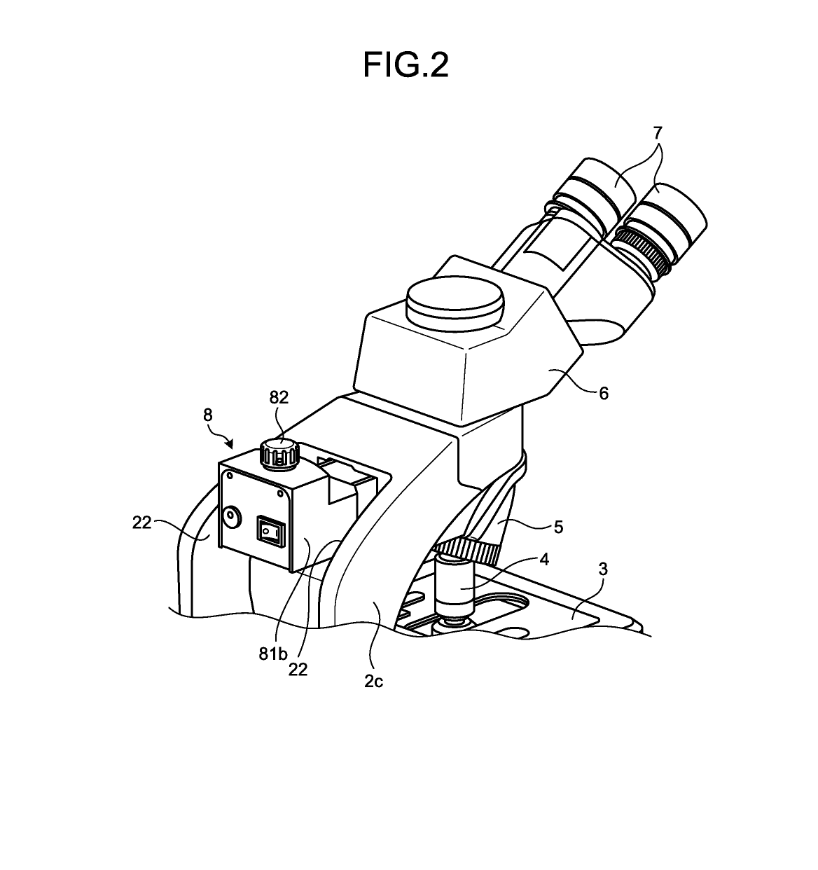

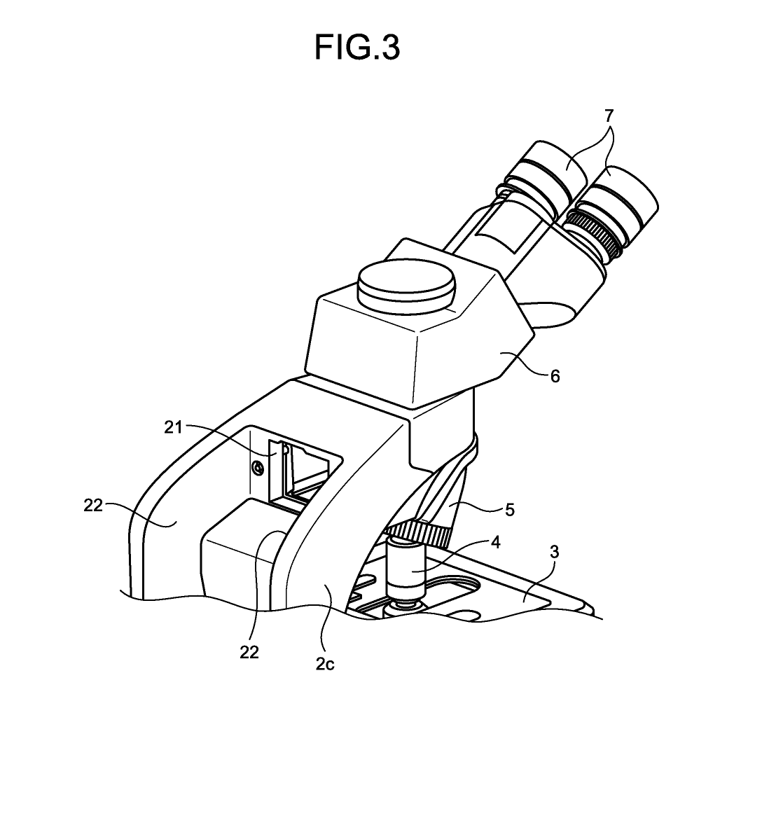

FIG. 2 is a diagram schematically illustrating a configuration of a main part of the microscope according to the first embodiment of the present invention, and is a diagram illustrating a configuration of a main part of the main body 2 that is in a state in which the optical unit 8 is inserted. FIG. 3 is a diagram schematically illustrating a configuration of a main part of the microscope according to the first embodiment of the present invention, and is a diagram illustrating a configuration of a main part of the main body 2 that is in a state in which the optical unit 8 is removed.

The arm portion 2c includes a revolver 5 (objective lens support portion) and an observation portion 6 (lens barrel). The revolver 5 is installed at a bottom part on a distal end side in an extending direction of the arm portion 2c. The observation portion 6 is installed at an upper part on the distal end side in the extending direction of the arm portion 2c. The revolver 5 and the observation portion 6 are disposed so as to face each other via the arm portion 2c.

For example, a plurality of objective lenses 4 having different magnifications can be attached to the revolver 5, and by rotating the revolver 5, observation can be performed with the objective lens 4 having a desired magnification being inserted onto the observation light path Nb.

An eyepiece 7 is attached to the observation portion 6. The observation portion 6 includes therein reflection mirrors 61 and 62 to guide observation light to the eyepiece 7 via the reflection mirrors 61 and 62, and forms an observation image at the eyepiece 7. The eyepiece 7 is formed by a tube lens and the like to magnify an intermediate image formed by the tube lens.

A holding portion 21 and a wall portion 22 are formed on the arm portion 2c. The holding portion 21 holds the optical unit 8 so as to be insertable and removable. The wall portion 22 is provided on a side connecting to the pillar portion 2b, and extends toward the back side to form a space connecting to an opening of the holding portion 21. The arm portion 2c includes an opening for passing the observation light path Nb. A plane P passing through the opening of the holding portion 21 that is provided on the side on which the optical unit 8 is inserted, and being parallel to a direction vertical to a placement surface (for example, direction parallel to the optical axis of the objective lens 4) is positioned between the pillar portion 2b and the observation portion 6. The opening of the holding portion 21 is thereby disposed at a position closer to the user. In this manner, by bringing the position of a grip portion 81b in the insertion of the optical unit 8 closer to the front face (user side), the operability of the optical unit 8 can be enhanced.

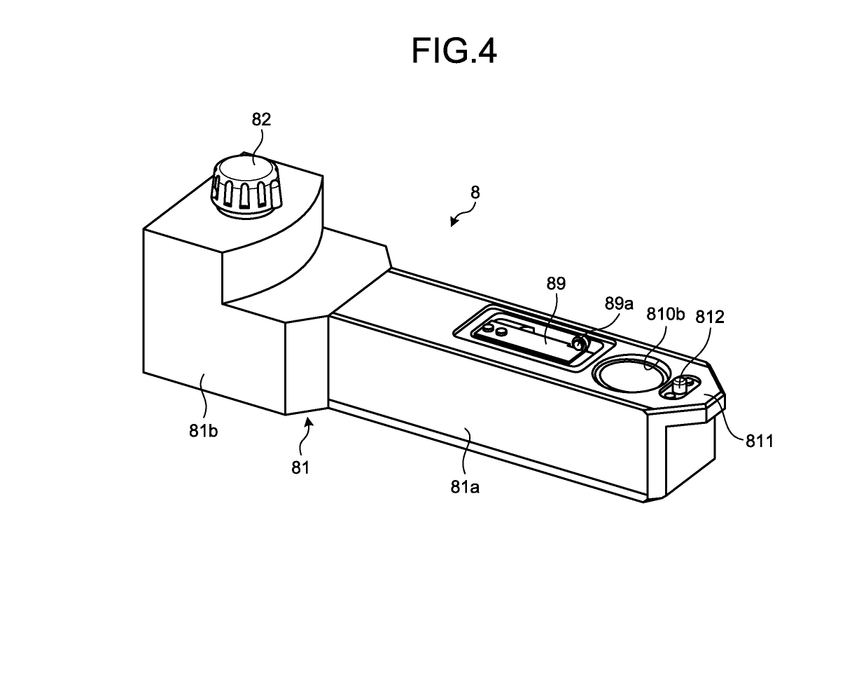

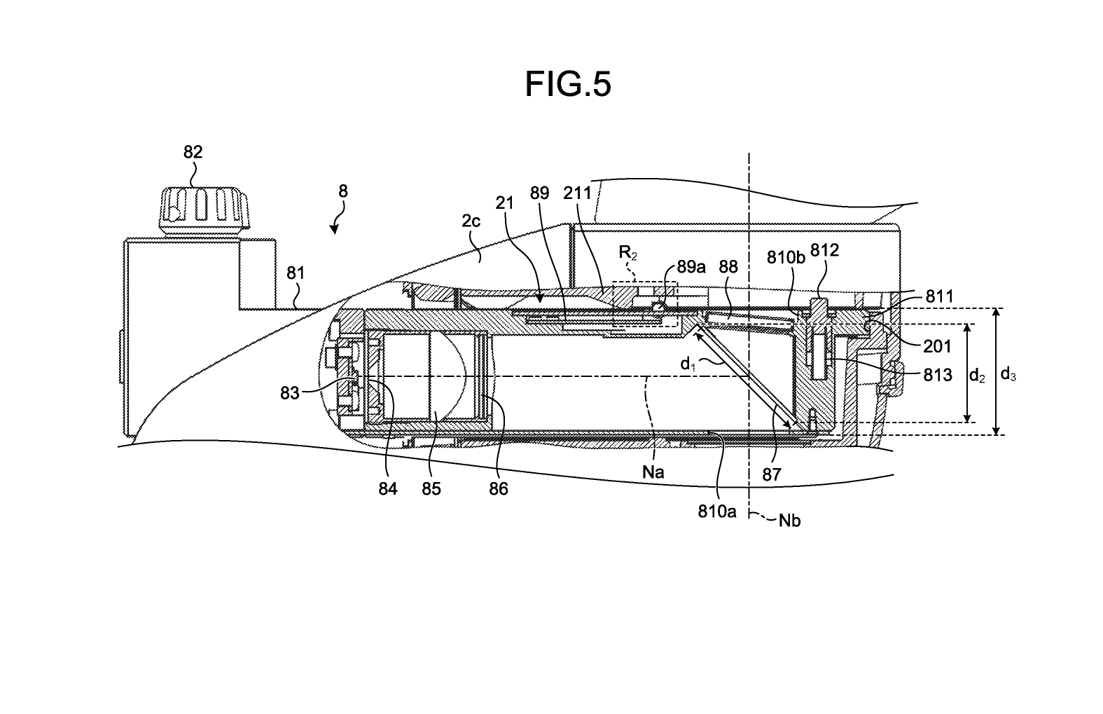

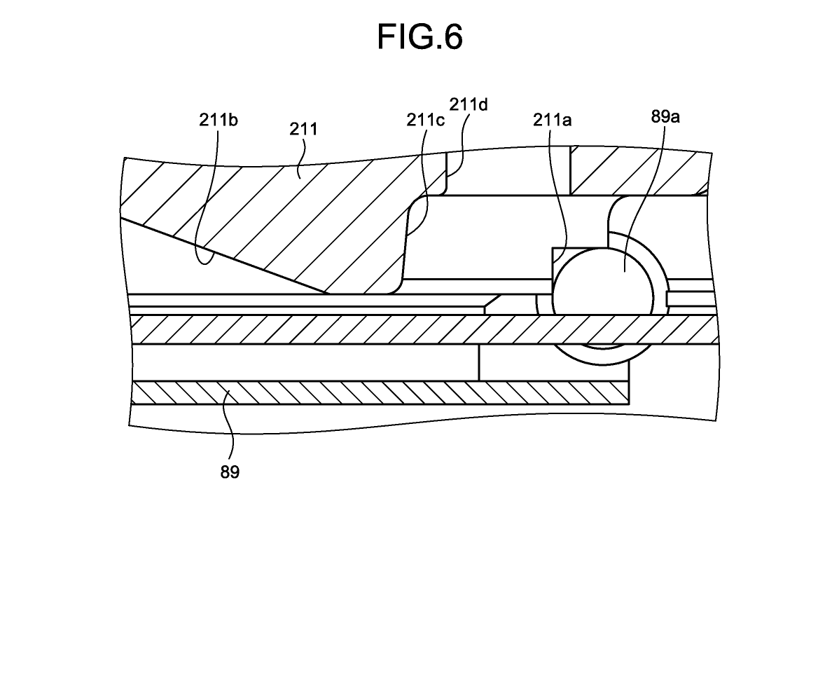

FIG. 4 is a perspective view schematically illustrating a configuration of an optical unit of the microscope according to the first embodiment of the present invention. FIG. 5 is a diagram illustrating a configuration of a region R₁ illustrated in FIG. 1. FIG. 6 is a diagram illustrating a configuration of a region R₂ illustrated in FIG. 5. The optical unit 8 includes a light source and an optical system for emitting epi-illumination light onto the specimen S.

The optical unit 8 includes a casing 81 having a longitudinal direction extending in a direction of inserting and removing the optical unit 8 into and from the main body 2. The casing 81 is a hollow prismatic body, and includes an optical holding portion 81a and the grip portion 81b. The optical holding portion 81a houses the light source and the illumination optical system. The grip portion 81b abuts the optical holding portion 81a in the longitudinal direction of the optical holding portion 81a, and is gripped by the user when the optical unit 8 is inserted into or removed from the main body 2.

Openings 810a and 810b for passing the observation light path Nb when the optical unit 8 is attached to the main body 2 are formed at an end portion on an opposite side of the grip portion 81b side of the optical holding portion 81a. The grip portion 81b is provided with a control board for controlling on/off and the like of the light source, a switch for performing an instruction input of the on/off, and a light adjustment operating unit 82 for adjusting a light amount of the light source (a light source 83 to be described below) included in the optical unit 8. The optical unit 8 itself may include a power source, and supply power to the light source 83, or power may be supplied via an external power source and the main body 2.

Inside the optical holding portion 81a, provided are the light source 83, a field diaphragm 84 for adjusting an illumination field formed by light emitted from the light source 83, a collector lens 85 for collecting light having passed through the field diaphragm 84, an excitation filter 86 for passing light having a specific wavelength band from the collector lens 85, a dichroic mirror 87 for bending the light having passed through the excitation filter 86, in a direction oriented toward the objective lens 4 on the observation light path Nb, and passing light having wavelength bands other than the wavelength band transmitted through the excitation filter 86, among the light having passed through the objective lens 4, and an absorption filter 88 for absorbing light having wavelength bands other than the specific wavelength band, among the light having passed through the dichroic mirror 87, and passing light having the specific wavelength band. The field diaphragm 84, the collector lens 85, the excitation filter 86, and the dichroic mirror 87 constitute an epi-illumination optical system for performing Kohler illumination for the specimen S. In the first embodiment, in a state in which the illumination light path Na of the optical unit 8 is disposed at the first position where the illumination light path Na connects to the observation light path Nb, the light source 83 and the exit pupil of the objective lens 4, and the field diaphragm 84 and the specimen S are disposed at positions conjugated to each other.

The optical holding portion 81a preferably has the minimum size that can store the light source 83, the epi-illumination optical system, and the excitation filter 86. Here, in the dichroic mirror 87 having the largest occupancy in a cross-section vertical to the longitudinal direction of the optical holding portion 81a, a length in a direction intersecting with a plane through which the illumination light path Na and the observation light path Nb pass, for example, a length of a side inclined with respect to the illumination light path Na among four sides of a rectangle is denoted by d₁ (refer to FIG. 5). When the dichroic mirror 87 is inclined by 45° with respect to the illumination light path Na, a height d₂ in the observation light path Nb direction of the optical holding portion 81a becomes d₂=d₁ sin 45°. For example, when the length d₁ is 38 mm, the height d₂ becomes about 26.9 mm. In this case, the optical holding portion 81a sets a height d₃ in the observation light path Nb direction to a height larger than 26.9 mm. At this time, it is preferable to design so as to have the minimum height that can store the illumination optical system and the like.

The light adjustment operating unit 82 includes a dial rotatable around a predetermined axis, and the like, and can perform a light amount change input according to an instruction position changing based on the rotation of itself. Illumination light emitted from the light source 83 is emitted with a light amount set according to the angle of rotation from a reference position in the light adjustment operating unit 82.

The light source 83 emits, for example, illumination light including light having a wavelength band to excite the specimen S. In other words, in the first embodiment, the illumination light emitted by the light source 83 travels along the illumination light path Na, an illumination field is adjusted by the field diaphragm 84, and the light is collected by the collector lens 85. After that, the illumination light having passed through the collector lens 85 becomes light (excitation light) having a specific wavelength band, i.e., a wavelength band including an excitation wavelength that excites the specimen S, by passing through the excitation filter 86. The excitation light is bent by the dichroic mirror 87, and emitted onto the specimen S via the objective lens 4. Fluorescence emitted by the specimen S being excited is taken into the objective lens 4, and light having wavelength bands other than the wavelength band of the excitation light passes through the dichroic mirror 87. After that, light having the wavelength band of the fluorescence of an observation target passes through the absorption filter 88, and observation light having passed through the absorption filter 88 forms an image at the eyepiece 7.

The casing 81 extends in a progressing and regressing direction of the optical unit 8, and includes a plate spring 89 elastically-deformable in a direction approaching or being separated from the main body 2. One end of the plate spring 89 is fixed by a screw or the like, and the plate spring 89 elastically deforms using this fixed end as a supporting point. The other end of the plate spring 89 is provided with a latch claw 89a.

A contact portion 811 contacting the main body 2 is formed in the casing 81. When the optical unit 8 is inserted into the main body 2, the contact portion 811 comes into contact with a wall surface 201 on the illumination side of the arm portion 2c.

As illustrated in FIG. 6, when the optical unit 8 is inserted into the holding portion 21 of the arm portion 2c, while deviating toward the inside of the casing 81, the latch claw 89a travels while sliding on an internal wall surface of the holding portion 21. After that, the latch claw 89a engages with a click step portion 211a immediately before or simultaneously with the contact portion 811 contacting the wall surface 201 of the arm portion 2c. The optical unit 8 is thereby latched at a position where the illumination light path Na intersects with the observation light path Nb, and connects to the observation light path Nb, and enters a state of being prevented from dropping out in a direction of retracting from the main body 2.

Furthermore, the casing 81 includes a latch portion 812 that can be latched to the main body 2 at a position retracted from the observation light path Nb of the optical unit 8, and a spring member 813 for biasing the latch portion 812 toward the outer surface of the casing 81 so as to be able to progress and regress.

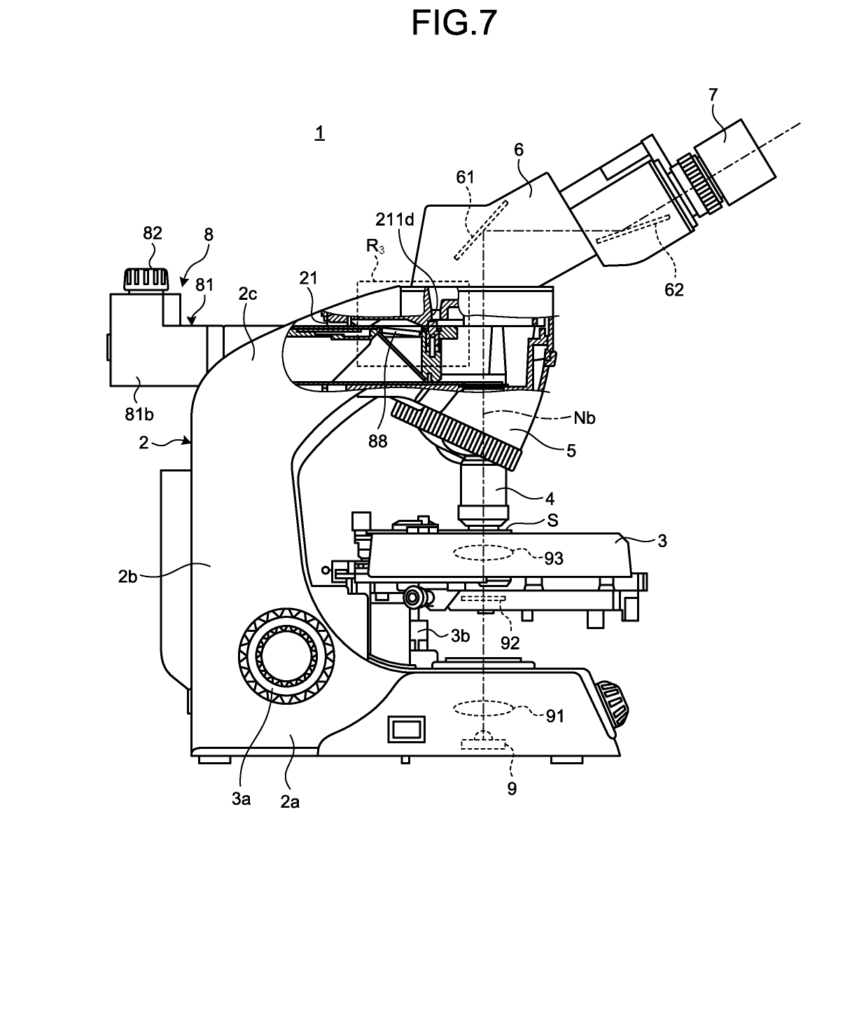

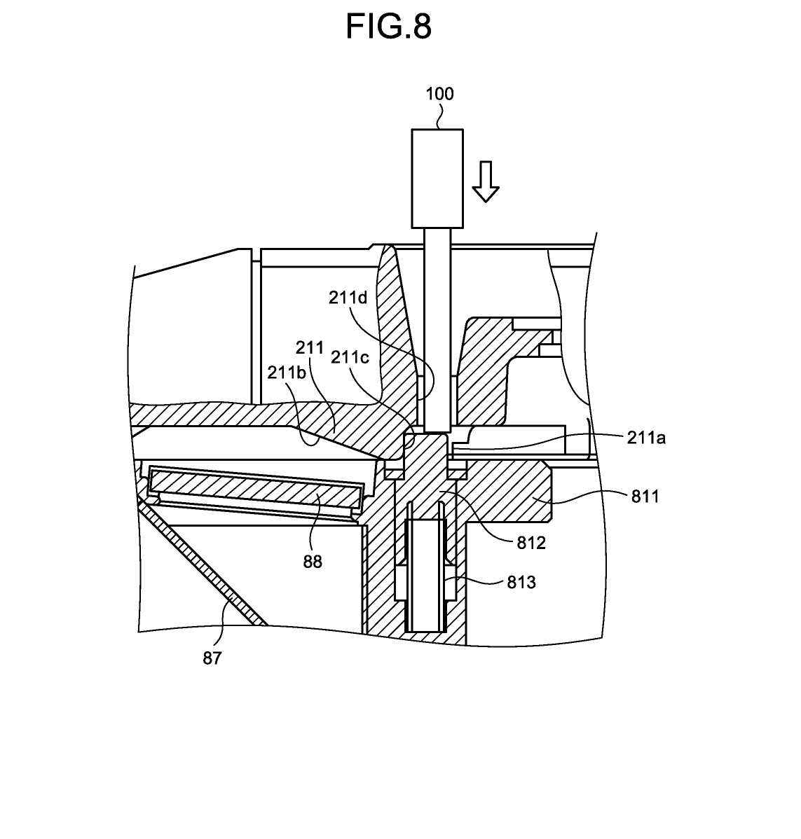

FIG. 7 is a schematic diagram illustrating a schematic configuration of the microscope according to the first embodiment of the present invention, and illustrates a state in which the dichroic mirror 87 of the optical unit 8 is retracted from the observation light path Nb. FIG. 8 is a diagram illustrating a configuration of a region R₃ illustrated in FIG. 7. When the optical unit 8 is inserted into the holding portion 21 of the arm portion 2c, the latch portion 812 advances while deviating toward the inside of the casing 81 along an inclined surface 211b of a protruding portion 211 formed inside the holding portion 21. After passing through a step portion 211c, the latch portion 812 enters a state of protruding from the outer surface of the casing 81 by the biasing of the spring member 813. If the optical unit 8 retracts from the main body 2 from this state, that is, if the dichroic mirror 87 of the optical unit 8 moves in a direction retracting from the observation light path Nb, the latch portion 812 comes into contact with the step portion 211c to be engaged therewith, and the optical unit 8 enters a state of being disposed at a second position where the illumination light path Na is retracted from the observation light path Nb (refer to FIG. 8). In the state illustrated in FIGS. 7 and 8, because the illumination light path Na of the optical unit 8 is retracted from the observation light path Nb, epi-illumination observation is not performed, and transmitted-light illumination observation can be performed by the light source 9. In this manner, in the first embodiment, by switching the position of the optical unit 8, the illumination light path Na of the epi-illumination optical system can take any of the first position where the illumination light path Na intersects with the observation light path Nb passing through the objective lens 4 attached to the revolver 5, and the second position where the illumination light path Na is retracted from the observation light path Nb. In the first embodiment, the latch portion 812, the spring member 813, and the step portion 211c constitute a regulating mechanism.

As illustrated in FIG. 2, when the optical unit 8 is inserted into the arm portion 2c, the optical unit 8 is in a state in which the grip portion 81b is disposed in a space formed by the wall portion 22, and part of the grip portion 81b is exposed from the arm portion 2c, and the grip portion 81b does not extend from the pillar portion 2b toward the back side. Thus, the user can easily grip the grip portion 81b even from the front face side.

When the optical unit 8 is removed from the main body 2, as illustrated in FIG. 8, by pulling out the optical unit 8 in a state in which the latch portion 812 is pressed by inserting a bar member 100 from a hole portion 211d formed in the arm portion 2c, the optical unit 8 can be removed from the main body 2.

In the first embodiment, the hole portion 211d is provided below the observation portion 6 (refer to FIG. 7), and the bar member 100 can be inserted thereinto in a state in which the observation portion 6 is removed. Alternatively, the hole portion 211d may be formed at a position deviated from an attachment region of the observation portion 6 so that the bar member 100 can be inserted thereinto without removing the observation portion 6.

According to the first embodiment, by switching an insertion position of the optical unit 8 with respect to the arm portion 2c, the illumination optical system is made insertable onto and removable from the observation light path Nb. Thus, an observation method, for example, epi-illumination observation and transmitted-light illumination observation can be switched without changes in heights of the observation portion 6 and the eyepiece 7 that are caused by the optical unit 8. With this configuration, the insertion and removal of an optical element, more specifically, the insertion and removal of the dichroic mirror 87 onto and from the observation light path Nb can be easily performed while suppressing a change in height of the observation portion 6 being a lens barrel. By suppressing a change in height of the lens barrel in this manner, a change in eyepoint of the user can be suppressed.

The conventional buildup method requires a countermeasure of, for example, making the thickness of an arm portion thinner for suppressing a change in eyepoint that is caused by the addition of an optical unit. Thus, the thinned arm portion may decrease rigidity. In contrast to this, in the first embodiment, because the height of the observation portion 6 does not change when the optical unit 8 is added to the main body 2, the thickness of the arm portion 2c needs not be made thinner, and a decrease in rigidity of the arm portion 2c can be suppressed.

In the first embodiment, because an exposed portion of the optical unit 8 inserted into the arm portion 2c is provided with the grip portion 81b, a good operability in the switching of an observation method can be realized.

In the first embodiment, because the wall portion 22 extending toward the back side is provided in the arm portion 2c, rigidity is added to the arm portion 2c, and the rigidity of the main body 2 can be enhanced.

In the first embodiment, although in the arm portion 2c, the optical unit 8 can take the first position and the second position, the optical unit 8 is only required to be located at least at the first position. In other words, when transmitted-light illumination observation is performed, the optical unit 8 may be removed from the arm portion 2c.

### Second Embodiment

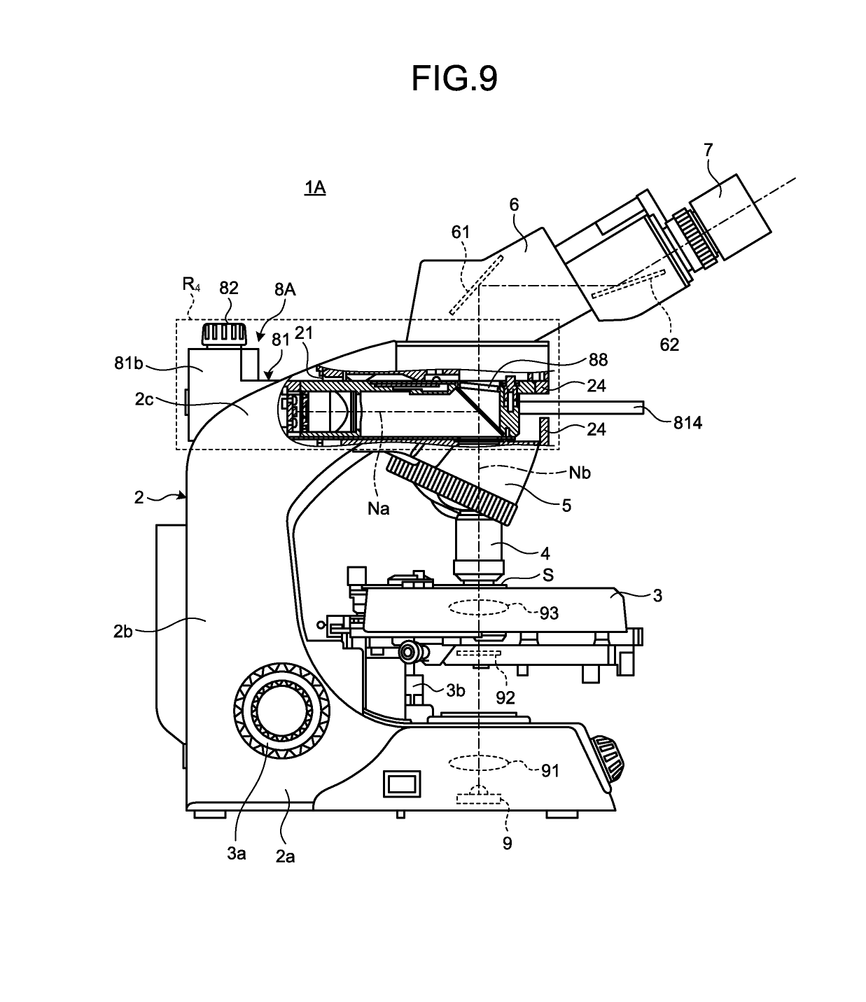

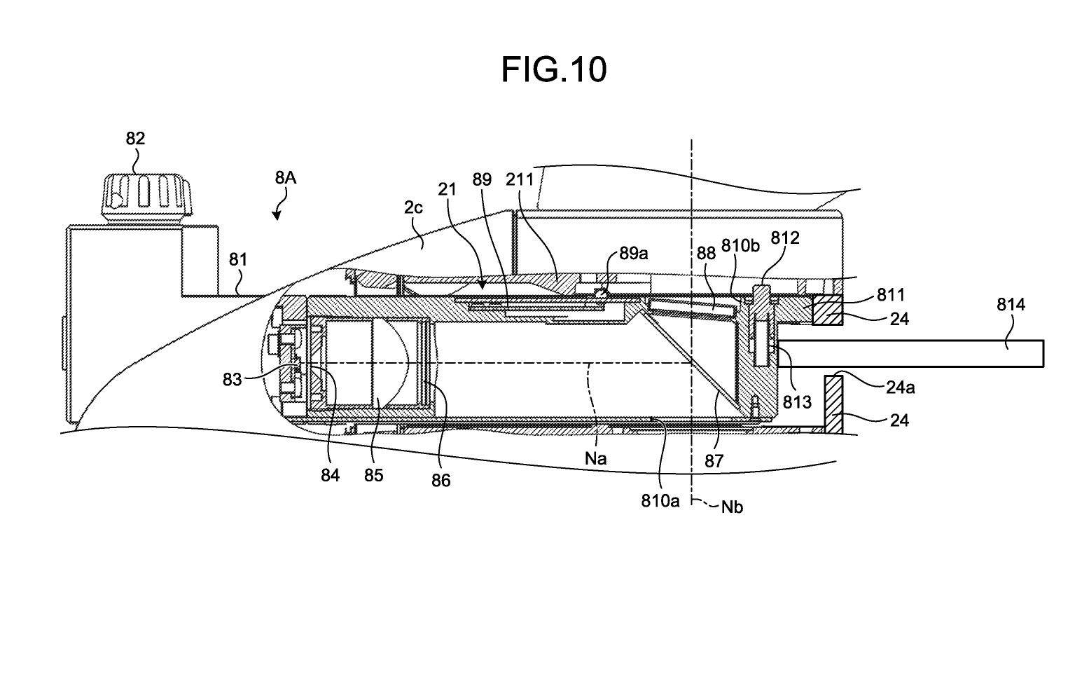

Next, a second embodiment of the present invention will be described. FIG. 9 is a schematic diagram illustrating a schematic configuration of a microscope according to the second embodiment of the present invention. FIG. 10 is a diagram illustrating a configuration of a region R₄ illustrated in FIG. 9. A microscope 1A according to the second embodiment includes an optical unit 8A in place of the optical unit 8.

The optical unit 8A includes a casing 81 having a longitudinal direction extending in a direction of inserting and removing the optical unit 8A into and from a main body 2. The casing 81 is a hollow prismatic body, and includes an optical holding portion 81a and a grip portion 81b. The optical holding portion 81a houses a light source and an illumination optical system. The grip portion 81b abuts the optical holding portion 81a in the longitudinal direction of the optical holding portion 81a, and is gripped by the user when the optical unit 8A is inserted into or removed from the main body 2. The grip portion 81b has a configuration similar to the aforementioned configuration.

In the optical unit 8A, in addition to the aforementioned configuration, the optical holding portion 81a is further provided with an operating member 814 for operating the movement of the position of the optical unit 8A with respect to an arm portion 2c. For example, the operating member 814 has a bar shape, and protrudes in an illumination light path Na direction from a surface from which a contact portion 811 of the optical holding portion 81a extends. At a position where the optical unit 8 is retracted from an observation light path Nb, the operating member 814 is located away from the observation light path Nb.

In the second embodiment, a hole portion 24a into which the operating member 814 can be inserted is formed in a wall portion 24 on the front face side of the arm portion 2c. If the optical unit 8 is inserted into a holding portion 21 from the rear surface, the operating member 814 protrudes toward the front face side from the hole portion 24a. The user can switch the position of the optical unit 8A with respect to the arm portion 2c by moving the operating member 814 back and forth in the longitudinal direction.

According to the second embodiment, similarly to the first embodiment, by switching an insertion position of the optical unit 8A with respect to the arm portion 2c, the illumination optical system is made insertable onto and removable from the observation light path Nb. Thus, an observation method, for example, epi-illumination observation and transmitted-light illumination observation can be switched without changes in positions of an observation portion 6 and an eyepiece 7 that are caused by the optical unit 8A. An optical element can be thereby easily inserted onto and removed from an observation light path while suppressing a change in eyepoint.

In addition, according to the second embodiment, because the operating member 814 protruding toward the front face side of the main body 2 is provided in the optical unit 8A, as compared with the first embodiment, the switching of an insertion position of the optical unit 8A with respect to the arm portion 2c can be performed further easily.

### Third Embodiment

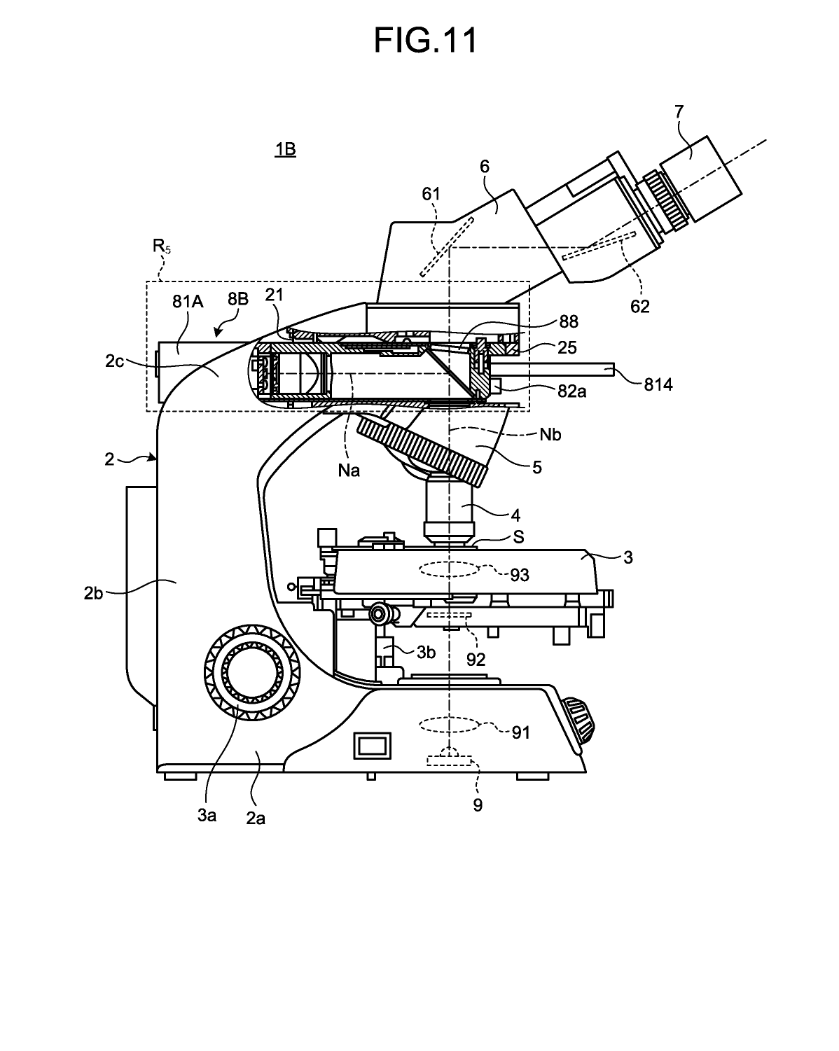

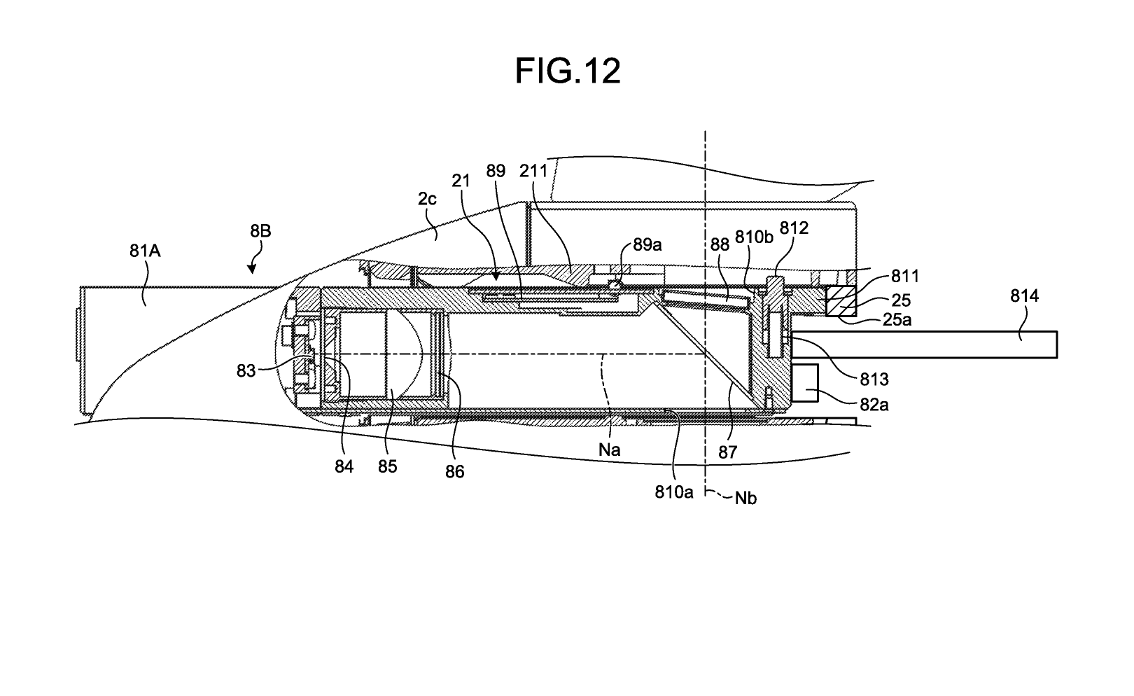

Next, a third embodiment of the present invention will be described. FIG. 11 is a schematic diagram illustrating a schematic configuration of a microscope according to the third embodiment of the present invention. FIG. 12 is a diagram illustrating a configuration of a region R₅ illustrated in FIG. 11. A microscope 1B according to the third embodiment includes an optical unit 8B in place of the optical unit 8.

The optical unit 8B includes a casing 81A having a longitudinal direction extending in a direction of inserting and removing the optical unit 8B into and from a main body 2. The casing 81A is a hollow prismatic body, and houses a light source and an illumination optical system.

The optical unit 8B includes an optical holding portion 81a. The optical holding portion 81a includes the operating member 814 and a light adjustment operating unit 82a that is provided at the distal end in a direction of inserting the optical unit 8B into a holding portion 21 and adjusts a light amount of a light source 83 of the optical unit 8B, in addition to the elements according to the first embodiment. The light adjustment operating unit 82a electrically connects to a control board via a cable or the like (not illustrated), and outputs information about a rotation angle of itself.

In the third embodiment, a hole portion 25a into which the operating member 814 can be inserted, and which exposes the light adjustment operating unit 82a is formed in a wall portion 25 on the front face side of an arm portion 2c. The user can switch the position of the optical unit 8B with respect to the arm portion 2c by moving the operating member 814 back and forth in the longitudinal direction, and furthermore, can adjust a light amount of the light source 83 by operating the light adjustment operating unit 82a from the front face side.

According to the third embodiment, similarly to the first embodiment, by switching an insertion position of the optical unit 8B with respect to the arm portion 2c, the illumination optical system is made insertable onto and removable from an observation light path Nb. Thus, an observation method, for example, epi-illumination observation and transmitted-light illumination observation can be switched without changes in positions of an observation portion 6 and an eyepiece 7 that are caused by the optical unit 8B. An optical element can be thereby easily inserted onto and removed from an observation light path while suppressing a change in eyepoint.

In addition, according to the third embodiment, in the optical unit 8B, because the light adjustment operating unit 82a is exposed to the front face side of the main body 2, as compared with the first embodiment, a light amount of the light source 83 can be adjusted further easily.

### Fourth Embodiment

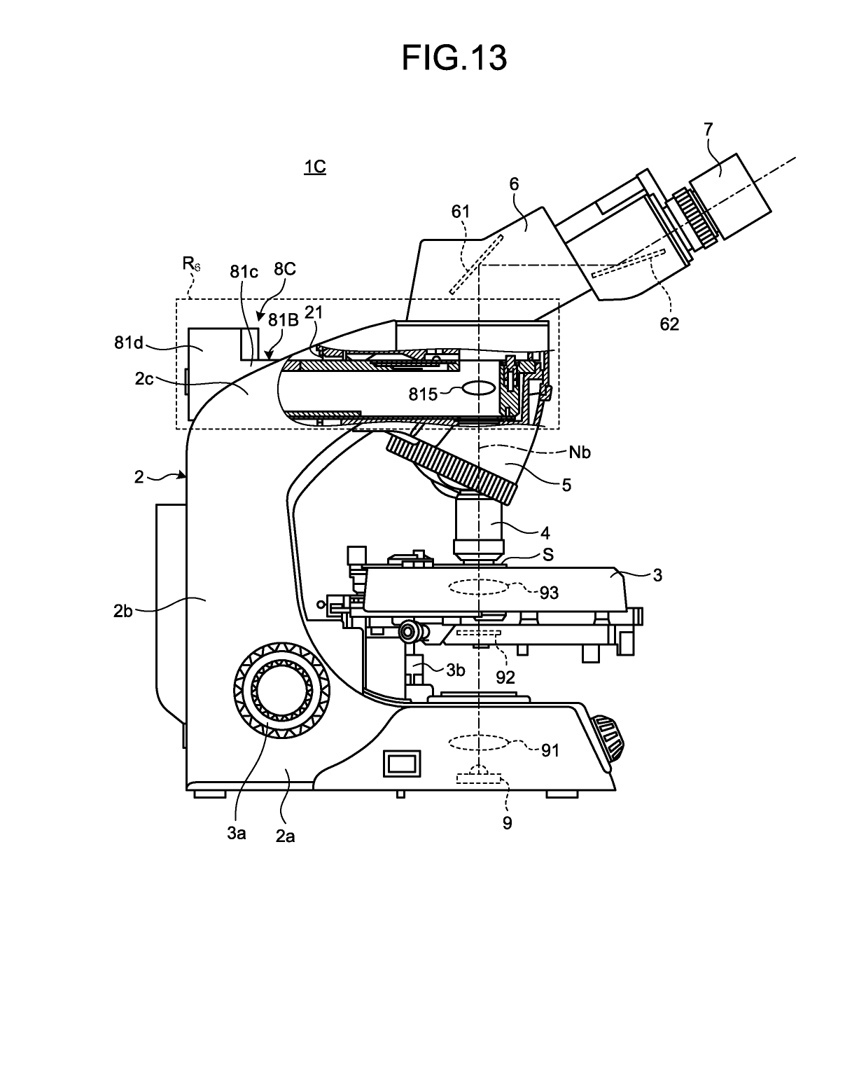

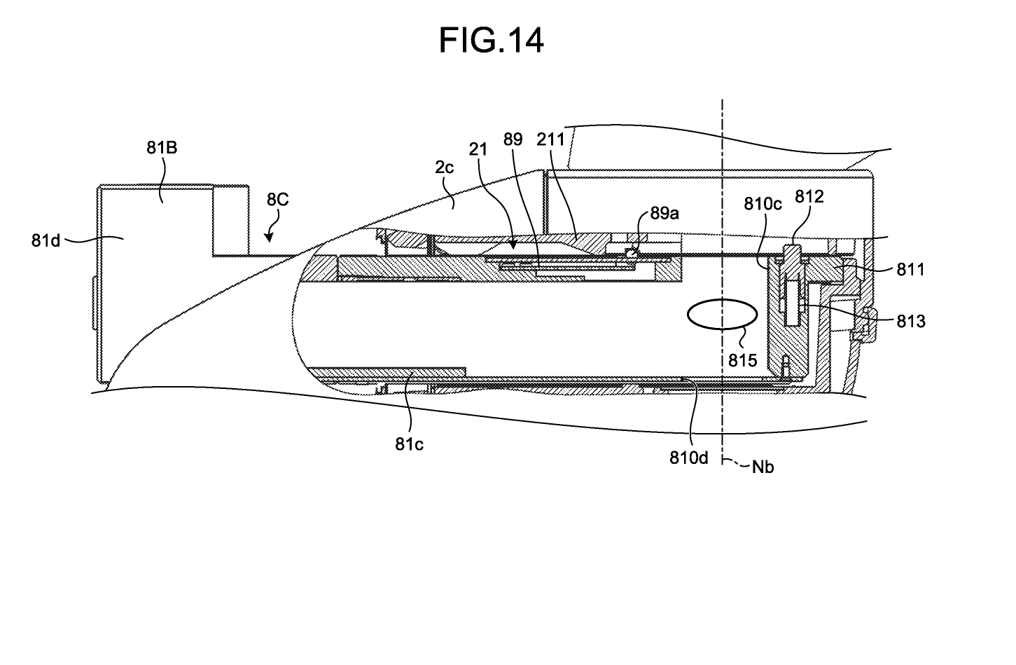

Next, a fourth embodiment of the present invention will be described. FIG. 13 is a schematic diagram illustrating a schematic configuration of a microscope according to the fourth embodiment of the present invention. FIG. 14 is a diagram illustrating a configuration of a region R₆ illustrated in FIG. 13. A microscope 10 according to the fourth embodiment includes an optical unit 8C in place of the optical unit 8.

The optical unit 8C includes a casing 81B having a longitudinal direction extending in a direction of inserting and removing the optical unit 8C into and from a main body 2. The casing 81B is a hollow prismatic body, and includes an optical holding portion 81c and a grip portion 81d. The optical holding portion 81c houses a light source and an illumination optical system. The grip portion 81d abuts the optical holding portion 81c in the longitudinal direction of the optical holding portion 81c, and is gripped by the user when the optical unit 8C is inserted into or removed from the main body 2.

Openings 810c and 810d for passing an observation light path Nb when the optical unit 8C is attached to the main body 2 are formed at an end portion on an opposite side of the grip portion 81d side of the optical holding portion 81c. A variable power lens 815 for varying an enlarging magnification of an observation image is provided in the optical holding portion 81c.

The casing 81B includes the plate spring 89. A contact portion 811 contacting the main body 2 is formed at the distal end in the insertion direction of the optical holding portion 81c. When the optical unit 8C is inserted into the main body 2, the contact portion 811 comes into contact with a wall surface on an illumination side of an arm portion 2c, and a latch claw 89a included in the plate spring 89 engages with a click step portion 211a (refer to FIG. 6). The optical unit 8C thereby enters a state of being positioned in a direction retracting from the main body 2.

Furthermore, the casing 81B includes the latch portion 812 and the spring member 813. With this configuration, also in the fourth embodiment, the optical unit 8C can be switched to a first position where the variable power lens 815 is disposed on the observation light path Nb, and a second position where the variable power lens 815 is retracted from the observation light path Nb (for example, refer to FIGS. 7 and 8). By switching the position of the optical unit 8C in this manner, in transmitted-light illumination observation performed using a light source 9, observation can be performed while switching the presence and absence of the variable power lens 815.

When the optical unit 8C is removed from the main body 2, as illustrated in FIG. 8, by pulling out the optical unit 8C in a state in which the latch portion 812 is pressed by inserting a bar member 100 from a hole portion 211d formed in the arm portion 2c, the optical unit 8C can be removed from the main body 2.

According to the fourth embodiment, by switching an insertion position of the optical unit 8C with respect to the arm portion 2c, the illumination optical system is made insertable onto and removable from the observation light path Nb. Thus, an observation method can be switched to, for example, observation with an enlarging magnification of an observation image that is varied by the variable power lens 815, without changes in positions of an observation portion 6 and an eyepiece 7 that are caused by the optical unit 8C. An optical element can be thereby easily inserted onto and removed from an observation light path while suppressing a change in eyepoint. As in the fourth embodiment, aside from the epi-illumination optical system in the first to third embodiments, an optical unit for changing an enlarging magnification may be employed. An optical unit including an optical element other than an illumination optical system may also be employed, such as an optical unit for performing differential interference contrast microscopy.

Modified Example of Fourth Embodiment

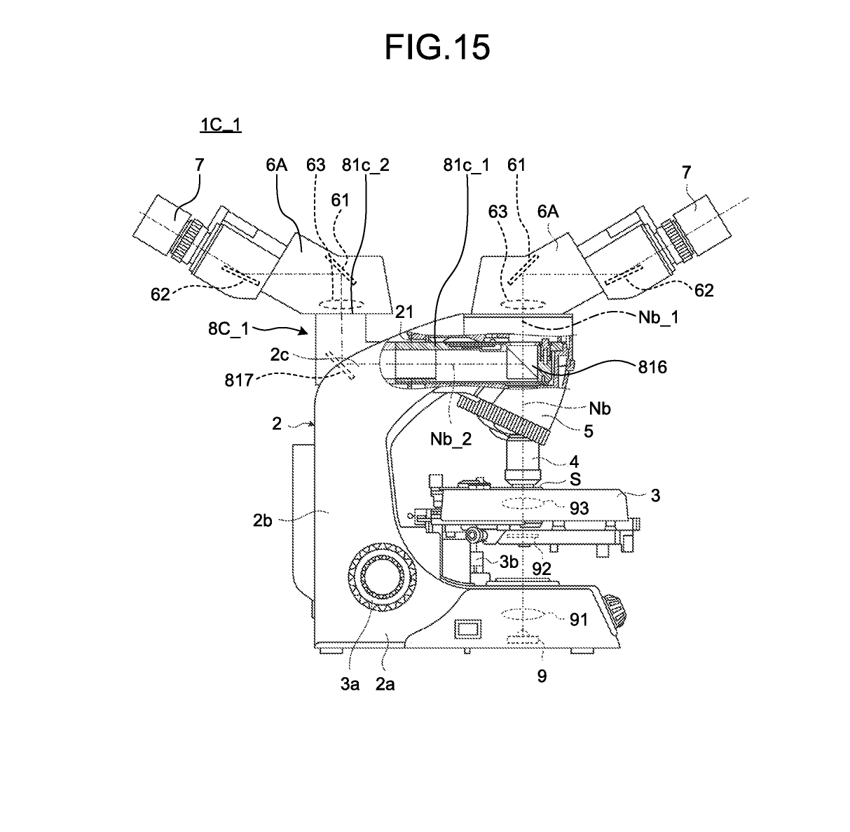

Next, a modified example of the fourth embodiment of the present invention will be described. FIG. 15 is a schematic diagram illustrating a schematic configuration of a microscope according to a modified example of the fourth embodiment of the present invention. A microscope 1C_1 according to this modified example includes an optical unit 8C_1 in place of the optical unit 8C. The microscope 1C_1 includes an observation portion 6A in place of the observation portion 6. Other configurations are similar to those in the first embodiment.

In addition to the reflection mirrors 61 and 62, the observation portion 6A includes a tube lens 63, and an eyepiece 7 is attached onto a light path of light reflected by the reflection mirror 62.

The longitudinal direction of the optical unit 8C_1 extends in an insertion and removal direction with respect to the main body 2, and the optical unit 8C_1 includes an optical holding portion 81c_1 being a casing for housing a prism 816 and a light reflecting mirror 817. The optical holding portion 81c_1 is provided with an attachment portion 81c_2 to which the observation portion 6A is attached. The observation portion 6A attached to the optical holding portion 81c_1 functions as a grip portion to be gripped by the user when the optical unit 8C_1 is inserted into and removed from the main body 2.

When the optical unit 8C_1 is attached to the main body 2, the prism 816 divides light on the observation light path Nb that has been taken into the objective lens 4, into light on an observation optical axis Nb_1 and light on an observation optical axis Nb_2. The light on the observation optical axis Nb_2 enters the light reflecting mirror 817, and is reflected by the light reflecting mirror 817, and then, enters the tube lens 63.

The light reflecting mirror 817 reflects light in a direction vertical to the observation optical axis Nb_2, for example.

An opening through which the observation light path Nb passes and an opening through which light toward the observation portion 6A passes when the optical unit 8C_1 is attached to the main body 2 are formed in the optical holding portion 81c_1. The optical holding portion 81c_1 includes elements related to the insertion and removal into and from the main body 2, such as the plate spring 89, the contact portion 811, the latch portion 812, and the spring member 813. Also in this modified example, the optical unit 8C_1 can be switched to a first position where the prism 816 is disposed on the observation light path Nb, and a second position where the prism 816 is retracted from the observation light path Nb. By switching the position of the optical unit 8C_1 in this manner, in transmitted-light illumination observation performed using the light source 9, observation can be performed while switching whether to cause observation light to enter the observation portion 6A on the optical unit 8C_1 side.

In this modified example, because the observation portion 6A is included as the optical unit 8C_1, the optical unit 8C_1 including the observation portion 6A functions as a facing discussion lens barrel by being used together with the observation portion 6A attached to the main body 2.

### Fifth Embodiment

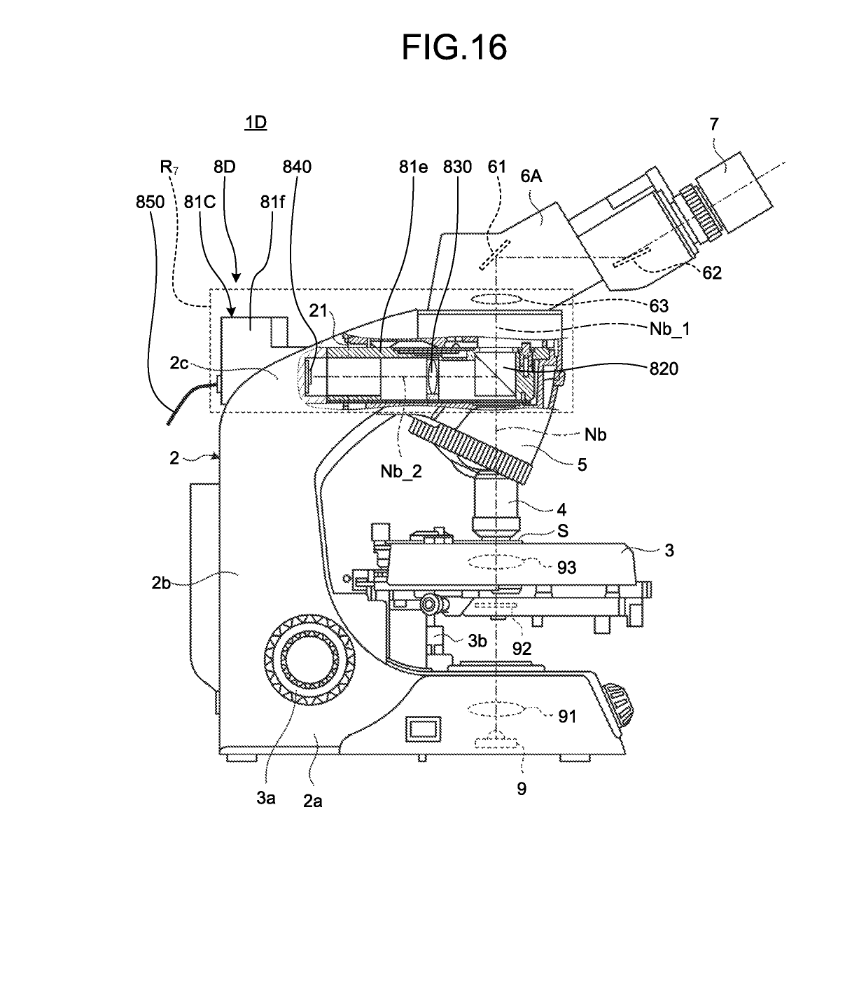

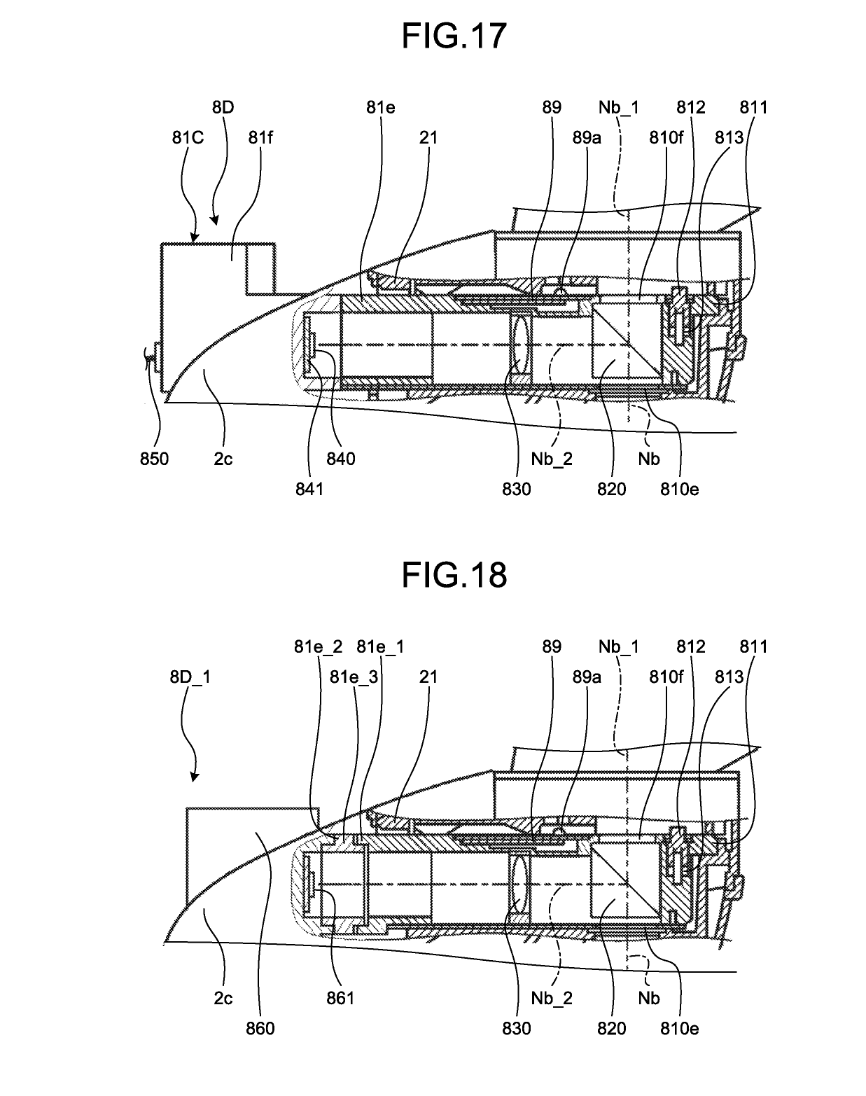

Next, a fifth embodiment of the present invention will be described. FIG. 16 is a schematic diagram illustrating a schematic configuration of a microscope according to the fifth embodiment of the present invention. FIG. 17 is a diagram illustrating a configuration of a region R₇ illustrated in FIG. 16. A microscope 1D according to the fifth embodiment includes an optical unit 8D in place of the optical unit 8. The microscope 1D includes an observation portion 6A in place of the observation portion 6. As described above, the observation portion 6A includes reflection mirrors 61 and 62 and a tube lens 63, and an eyepiece 7 is attached onto a light path of light reflected by the reflection mirror 62. Other configurations are similar to those in the first embodiment.

The optical unit 8D includes a casing 81C having a longitudinal direction extending in an insertion and removal direction with respect to a main body 2. The casing 81C includes an optical holding portion 81e and a grip portion 81f. The optical holding portion 81e houses a prism 820, a tube lens 830, and an image sensor 840. The grip portion 81f abuts the optical holding portion 81e in the longitudinal direction of the optical holding portion 81e, and is gripped by the user when the optical unit 8D is inserted into or removed from the main body 2. In the fifth embodiment, the prism 820 and the tube lens 830 form an image forming optical system.

When the optical unit 8D is attached to the main body 2, the prism 820 divides light on an observation light path Nb that has been taken into an objective lens 4, into light with an observation optical axis Nb_1 and light with an observation optical axis Nb_2. Among the light divided by the prism 820, the light with the observation optical axis Nb_2 enters the tube lens 830, and light formed by the tube lens 830 enters the image sensor 840.

The image sensor 840 is mounted on a substrate 841. The substrate 841 is connected to a driving substrate (illustration is omitted) via an internal cable (not illustrated). The driving substrate is electrically connected with a cable 850 for connecting to an external processing apparatus. Image data acquired by the image sensor 840 is input to the external processing apparatus via the cable 850. In the external processing apparatus, image data is generated based on an electrical signal generated through photoelectric conversion performed by the image sensor 840. The image data is displayed on the processing apparatus, another monitor, or the like.

An opening 810e through which the observation light path Nb passes and an opening 810f through which light toward the observation portion 6A passes when the optical unit 8D is attached to the main body 2 are formed at an end portion on an opposite side of the grip portion 81f side of the optical holding portion 81e.

The casing 81C includes the plate spring 89. A contact portion 811 contacting the main body 2 is formed at the distal end in the insertion direction of the optical holding portion 81e. When the optical unit 8D is inserted into the main body 2, the contact portion 811 comes into contact with a wall surface on an illumination side of an arm portion 2c, and a latch claw 89a included in the plate spring 89 engages with a click step portion 211a (refer to FIG. 6). The optical unit 8D thereby enters a state of being positioned in a direction retracting from the main body 2.

Furthermore, the casing 81C includes the latch portion 812 and the spring member 813. With this configuration, also in the fifth embodiment, the optical unit 8D can be switched to a first position where the prism 820 is disposed on the observation light path Nb, and a second position where the prism 820 is retracted from the observation light path Nb. By switching the position of the optical unit 8D in this manner, in transmitted-light illumination observation performed using a light source 9, observation can be performed while switching whether to cause observation light to enter the image sensor 840.

When the optical unit 8D is removed from the main body 2, as described above, by pulling out the optical unit 8D in a state in which the latch portion 812 is pressed by inserting a bar member 100 from a hole portion 211d formed in the arm portion 2c, the optical unit 8D can be removed from the main body 2.

According to the fifth embodiment, similarly to the first embodiment, by switching an insertion position of the optical unit 8D with respect to the arm portion 2c, the image forming optical system is made insertable onto and removable from the observation light path Nb. Thus, an observation method, more specifically, observation using the observation portion 6A and observation using an image that is based on an electrical signal generated by the image sensor 840 can be switched without changes in positions of the observation portion 6A and the eyepiece 7 that are caused by the optical unit 8D. An optical element can be thereby easily inserted onto and removed from an observation light path while suppressing a change in eyepoint.

In addition, according to the fifth embodiment, because the optical unit 8D includes the image forming optical system, an image of a specimen S can be acquired. If a focal length of the tube lens 830 is shortened without using a focal length common to the tube lens 63 of the observation portion 6A, the total length of the casing 81C can be shortened by using the image sensor 840 having a small size. Thus, a compact and easily-handled optical unit can be provided. Furthermore, according to the fifth embodiment, because a gravity center can be kept low even if the optical unit 8D is attached to the main body 2, safety is enhanced. Furthermore, because the entire height does not become high, storage easiness is enhanced. On the other hand, in the convention technique, when a unit for capturing a specimen image is provided, a trinocular lens barrel, a tube lens straight tube, and a trinocular intermediate lens-barrel have been assembled onto a frame (e.g., arm portion) of a microscope, and a camera has been stacked thereonto. Thus, the entire height of the microscope has been high.

In the fifth embodiment, by using the prism 820 that divides light based on a light path division ratio for guiding observation light toward both the observation portion 6A side and the image sensor 840 side, visual observation and observation using an image obtained by the image sensor 840 can be simultaneously performed. In the fifth embodiment, a light path is divided using the prism 820. Alternatively, instead of a prism that divides a light path, a mirror for reflecting observation light toward the tube lens 830 may be used. In this case, as compared with a case of dividing a light path, a brighter image can be obtained. Meanwhile, if the optical unit 8D is disposed at the second position, observation using the observation portion 6A can be performed.

First Modified Example of Fifth Embodiment

Next, a first modified example of the fifth embodiment of the present invention will be described. FIG. 18 is a schematic diagram illustrating a configuration of a main part of a microscope according to the first modified example of the fifth embodiment of the present invention. The microscope according to the first modified example includes an optical unit 8D_1 in place of the optical unit 8D.

The longitudinal direction of the optical unit 8D_1 extends in an insertion and removal direction with respect to a main body 2, and the optical unit 8D_1 includes an optical holding portion 81e_1 being a casing for housing a prism 820 and a tube lens 830. A camera unit 860 is attached to the optical holding portion 81e_1 via an attachment portion 81e_2. An opening 810e through which the observation light path Nb passes and an opening 810f through which light toward the observation portion 6A passes when the optical unit 8D_1 is attached to the main body 2 are formed in the optical holding portion 81e_1. The optical holding portion 81e_1 includes elements related to the insertion and removal into and from the main body 2, such as the plate spring 89, the contact portion 811, the latch portion 812, and the spring member 813.

The attachment portion 81e_2 is provided with a parfocality adjustment unit 81e_3. The parfocality adjustment unit 81e_3 is realized by a configuration that can move the camera unit 860 in an observation optical axis Nb_2 direction, i.e., a known driving system such as, for example, a screw driving system. The camera unit 860 includes an image sensor 861, and functions as a grip portion to be gripped by the user when the optical unit 8D_1 is inserted into and removed from the main body 2. The camera unit 860 may include a signal processor for processing an electrical signal generated by the image sensor 861, and a storage for storing the electrical signal and image data obtained based on the electrical signal.

In the first modified example, a distance between the tube lens 830 and the camera unit 860 can be adjusted by the parfocality adjustment unit 81e_3 according to the characteristics of the camera unit 860 to be attached.

According to the first modified example, in a configuration in which the image sensor 861 is separately provided as the camera unit 860, the camera unit 860 can be selected according to the desire of the user. Thus, system extensibility is enhanced.

Second Modified Example of Fifth Embodiment

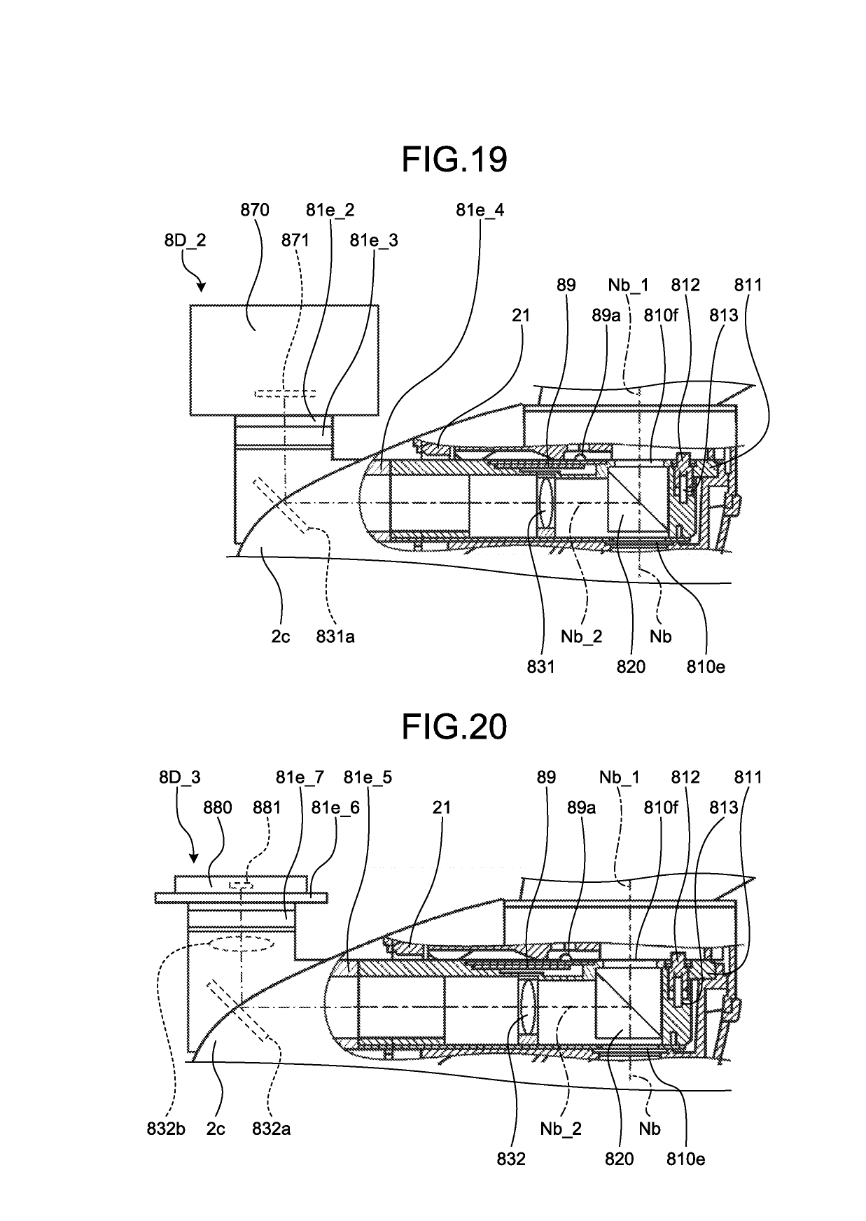

Next, a second modified example of the fifth embodiment of the present invention will be described. FIG. 19 is a schematic diagram illustrating a configuration of a main part of a microscope according to the second modified example of the fifth embodiment of the present invention. The microscope according to the second modified example includes an optical unit 8D_2 in place of the optical unit 8D_1.

The longitudinal direction of the optical unit 8D_2 extends in an insertion and removal direction with respect to a main body 2, and the optical unit 8D_2 includes an optical holding portion 81e_4 being a casing for housing an image forming optical system formed by a prism 820, a tube lens 831 and a light reflecting mirror 831a. The tube lens 831 has a focal length longer than that of the tube lens 830. The light reflecting mirror 831a reflects light in a direction vertical to the observation optical axis Nb_2, for example.

A camera unit 870 is attached to the optical holding portion 81e_4 via an attachment portion 81e_2. The attachment portion 81e_2 is provided with a parfocality adjustment unit 81e_3. The camera unit 870 includes an image sensor 871, and functions as a grip portion to be gripped by the user when the optical unit 8D_2 is inserted into and removed from the main body 2. The camera unit 870 may include a signal processor for processing an electrical signal generated by the image sensor 871, and a storage for storing the electrical signal and image data obtained based on the electrical signal.

An opening 810e through which the observation light path Nb passes and an opening 810f through which light toward the observation portion 6A passes when the optical unit 8D_2 is attached to the main body 2 are formed in the optical holding portion 81e_4. The optical holding portion 81e_4 includes elements related to the insertion and removal into and from the main body 2, such as the plate spring 89, the contact portion 811, the latch portion 812, and the spring member 813.

In the second modified example, similarly to the first modified example, a distance between the tube lens 831 and the camera unit 870 can be adjusted by the parfocality adjustment unit 81e_3 according to the characteristics of the camera unit 870 to be attached.

According to the second modified example, the camera unit 870 is disposed at an upper part of the arm portion 2c, and light on the observation light path Nb_2 is bent. With this configuration, even if the large-sized camera unit 870 is provided, contact with a wall portion 22 of the arm portion 2c can be avoided without elongating the depth of the casing. Thus, a system can be expanded in a reduced space.

Third Modified Example of Fifth Embodiment

Next, a third modified example of the fifth embodiment of the present invention will be described. FIG. 20 is a schematic diagram illustrating a configuration of a main part of a microscope according to the third modified example of the fifth embodiment of the present invention. The microscope according to the third modified example includes an optical unit 8D_3 in place of the optical unit 8D_2.

The longitudinal direction of the optical unit 8D_3 extends in an insertion and removal direction with respect to a main body 2, and the optical unit 8D_3 includes an optical holding portion 81e_5 being a casing for housing an image forming optical system formed by a prism 820, a tube lens 832, a light reflecting mirror 832a, and an eyepiece 832b. The tube lens 832 has a focal length longer than that of the tube lens 830. The light reflecting mirror 832a reflects light in a direction vertical to the observation optical axis Nb_2, for example. The eyepiece 832b is a lens for forming an image in a portable device 880 having an imaging function that is to be installed, such as a smartphone. An end portion of the optical holding portion 81e_5 on an opposite side of a side inserted into the main body 2 functions as a grip portion to be gripped by the user when the optical unit 8D_3 is inserted into and removed from the main body 2.

The portable device 880 is attached to the optical holding portion 81e_5 via a mount portion 81e_6. A parfocality adjustment unit 81e_7 is provided between the optical holding portion 81e_5 and the mount portion 81e_6. The parfocality adjustment unit 81e_7 is realized by using a configuration similar to those of the parfocality adjustment unit 81e_3, and adjusts a distance between the eyepiece 832b and a camera portion 881 including an image sensor that is included in the portable device 880. An opening 810e through which the observation light path Nb passes and an opening 810f through which light toward the observation portion 6A passes when the optical unit 8D_3 is attached to the main body 2 are formed in the optical holding portion 81e_5. The optical holding portion 81e_5 includes elements related to the insertion and removal into and from the main body 2, such as the plate spring 89, the contact portion 811, the latch portion 812, and the spring member 813.

In the third modified example, similarly to the first modified example, a distance between the eyepiece 832b and the camera portion 881 of the portable device 880 can be adjusted by the parfocality adjustment unit 81e_7 according to the characteristics of the portable device 880 to be attached.

As in the third modified example, since the portable device 880 having the imaging function is attached to the optical unit 8D_3, an image of a specimen S can be easily acquired by the camera portion 881.

Fourth Modified Example of Fifth Embodiment

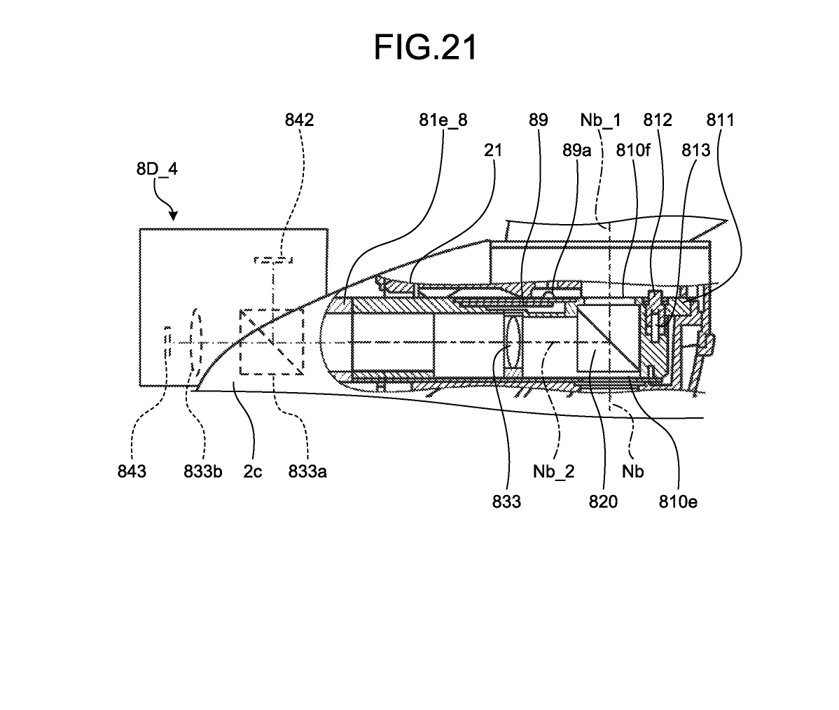

Next, a fourth modified example of the fifth embodiment of the present invention will be described. FIG. 21 is a schematic diagram illustrating a configuration of a main part of a microscope according to the fourth modified example of the fifth embodiment of the present invention. The microscope according to the fourth modified example includes an optical unit 8D_4 in place of the optical unit 8D.

The longitudinal direction of the optical unit 8D_4 extends in a direction of inserting and removing the optical unit 8D_4 into and from a main body 2, and the optical unit 8D_4 includes an optical holding portion 81e_8 being a casing for housing a prism 820 (first prism), a tube lens 833, a second prism 833a, a collector lens 833b, an image sensor 842, and a light source 843. An end portion of the optical holding portion 81e_8 on an opposite side of a side inserted into the main body 2 functions as a grip portion to be gripped by the user when the optical unit 8D_4 is inserted into and removed from the main body 2. In the fourth modified example, an image forming optical system is formed by the prism 820, the tube lens 833, and the second prism 833a.

The second prism 833a forms a light source image by transmitting part of light transmitted through the collector lens 833b. Illumination light using the light source image as a secondary light source passes through the tube lens 833 serving as a field lens, and is partially reflected by the prism 820, to form again a light source image at a pupil position of the objective lens 4. Using the light source image as a tertiary light source, the objective lens 4 itself serves as a condenser, and light based on the tertiary light source is emitted onto the specimen S as uniform epi-illumination light. In the fourth modified example, an epi-illumination optical system is formed by the prism 820, the tube lens 833, the second prism 833a, and the collector lens 833b. The second prism 833a bends part of light having passed through the tube lens 833 from the prism 820 side, toward the image sensor 842 side. The image sensor 842 and the light source 843 drive under the control of the main body 2 or an external processing apparatus via a cable (not illustrated).

An opening 810e through which the observation light path Nb passes and an opening 810f through which light toward the observation portion 6A passes when the optical unit 8D_4 is attached to the main body 2 are formed in the optical holding portion 81e_8. The optical holding portion 81e_8 includes elements related to the insertion and removal into and from the main body 2, such as the plate spring 89, the contact portion 811, the latch portion 812, and the spring member 813.

As in the fourth modified example, in the configuration including the image forming optical system and the epi-illumination optical system, by attaching the optical unit 8D_4, epi-illumination using uniform illumination light can be performed, and an observation image from the specimen S can be acquired.

Also in the first to fourth modified examples, a mirror for reflecting observation light may be used in place of the prism 820.

### Sixth Embodiment

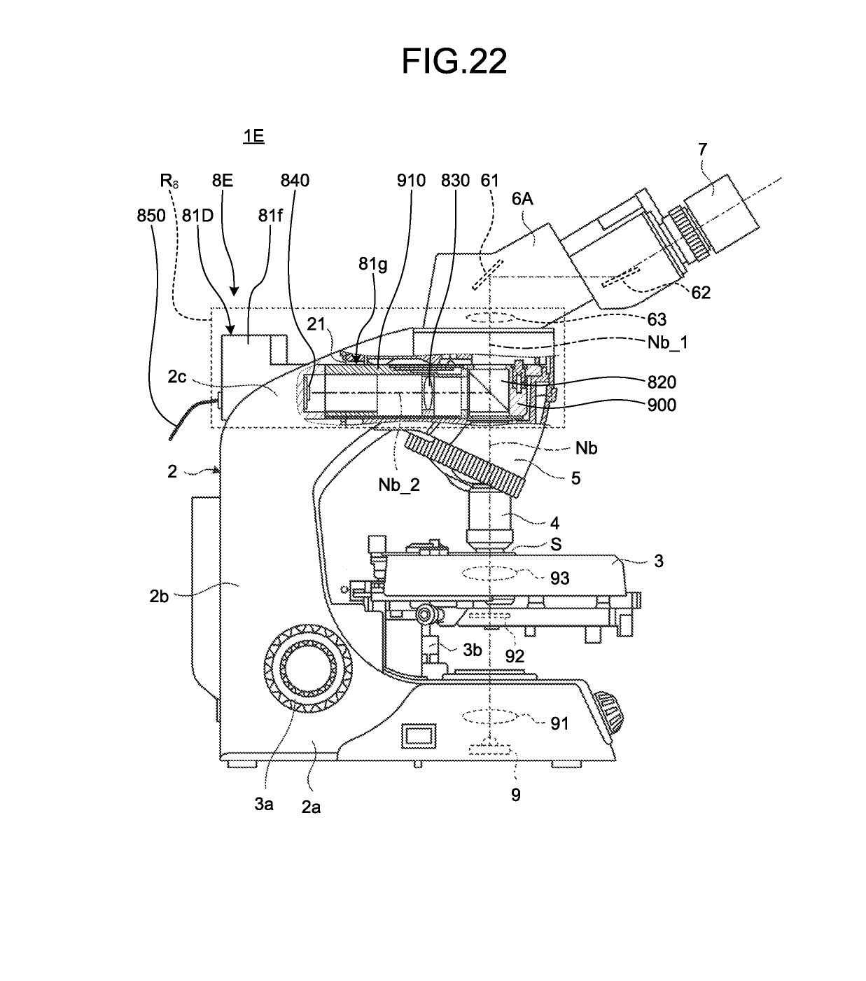

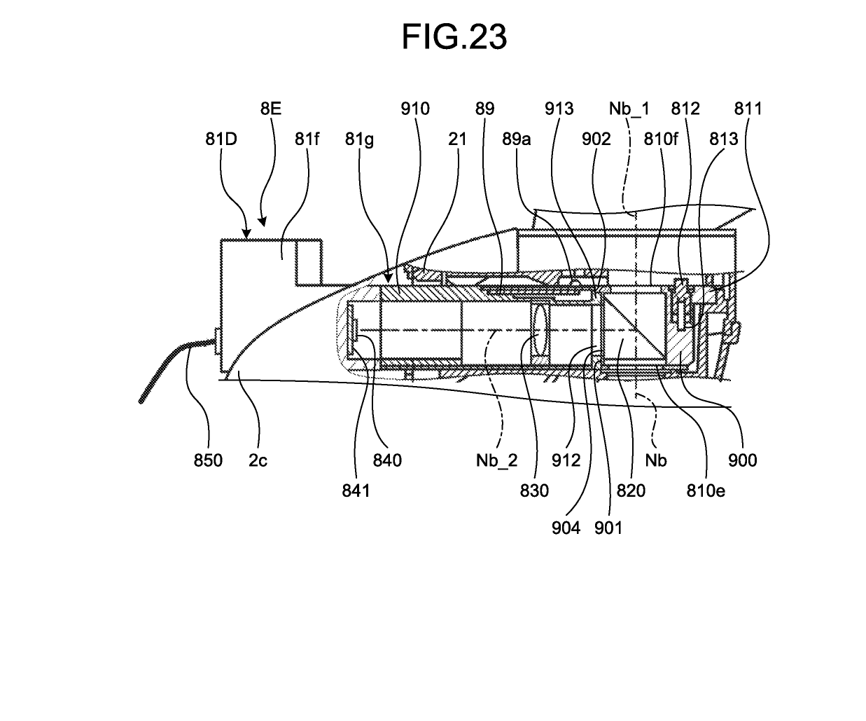

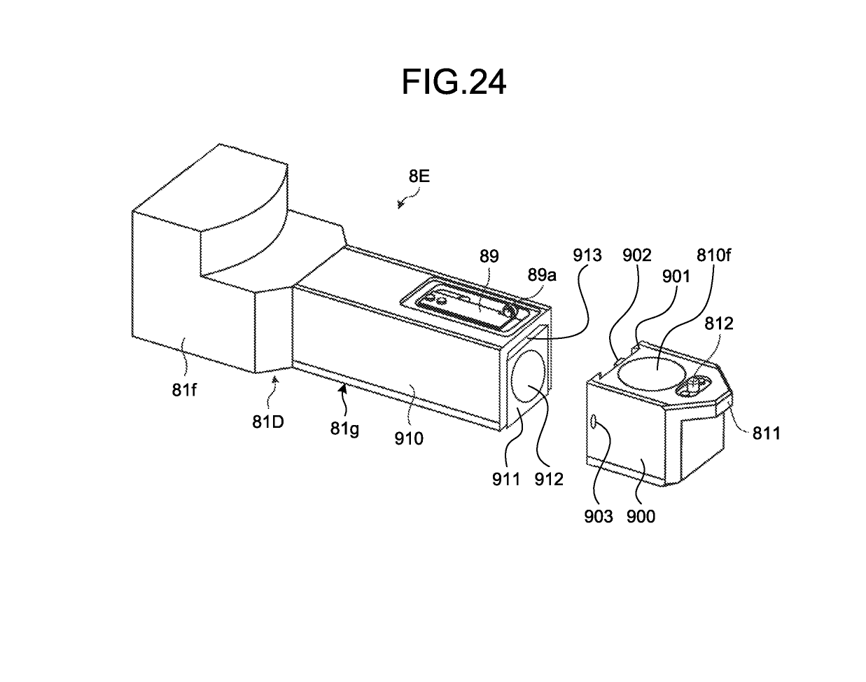

Next, a sixth embodiment of the present invention will be described. FIG. 22 is a schematic diagram illustrating a schematic configuration of a microscope according to the sixth embodiment of the present invention. FIG. 23 is a diagram illustrating a configuration of a region R₈ illustrated in FIG. 22. FIG. 24 is a schematic diagram illustrating a configuration of a main part of the microscope according to the sixth embodiment of the present invention, and is a diagram illustrating a configuration of an optical unit. A microscope 1E according to the sixth embodiment includes an optical unit 8E in place of the optical unit 8, and further includes an observation portion 6A in place of the observation portion 6. Other configurations are similar to those in the first embodiment.

The optical unit 8E includes a casing 81D having a longitudinal direction extending in an insertion and removal direction with respect to a main body 2. The casing 81D includes an optical holding portion 81g and a grip portion 81f. The optical holding portion 81g houses an image forming optical system formed by a prism 820, a tube lens 830, and an image sensor 840. The grip portion 81f abuts the optical holding portion 81g in the longitudinal direction of the optical holding portion 81g, and is gripped by the user when the optical unit 8E is inserted into or removed from the main body 2. The prism 820, the tube lens 830, and the image sensor 840 are similar to those in the fifth embodiment. Image data acquired by the image sensor 840 is input to the external processing apparatus via the cable 850.

The optical holding portion 81g includes a light path division portion 900 for holding the prism 820, and an optical main body portion 910 for holding the tube lens 830 and the image sensor 840. The light path division portion 900 is detachably attached to the optical main body portion 910, and corresponds to a light path changing unit.

In the optical main body portion 910, on a surface connecting to the light path division portion 900, a slide male dovetail 911 is formed. In the slide male dovetail 911, an opening 912 for passing light bent by the prism 820 in an observation optical axis Nb_2 direction is formed. The slide male dovetail 911 includes a positioning wall 913 being a surface for positioning the light path division portion 900 by contacting part of the light path division portion 900 when the light path division portion 900 is attached.

In the light path division portion 900, on a surface connecting to the optical main body portion 910, a slide female dovetail 901 to be engaged with the slide male dovetail 911 is formed. In the slide female dovetail 901, an opening 904 for emitting light bent by the prism 820 in the observation optical axis Nb_2 direction is formed. The light path division portion 900 includes a projection portion 902 that contacts the positioning wall 913 when the light path division portion 900 is attached to the optical main body portion 910, and a fixing screw 903 for fixing the light path division portion 900 to the optical main body portion 910 with being in contact with the optical main body portion 910.

An opening 810e through which the observation light path Nb passes and an opening 810f through which light toward the observation portion 6A passes when the optical unit 8E is attached to the main body 2 are formed at an end portion of the light path division portion 900 on an opposite side of a side connecting to the optical main body portion 910.

The light path division portion 900 and the optical main body portion 910 are connected to each other by being slid in a state in which the slide female dovetail 901 and the slide male dovetail 911 are engaged. At this time, by the projection portion 902 contacting the positioning wall 913, the light path division portion 900 is positioned with respect to the optical main body portion 910. By screwing the fixing screw 903 into the optical main body portion 910 after the positioning, the light path division portion 900 is fixed onto the optical main body portion 910. By loosening the fixing screw 903, the light path division portion 900 can be removed from the optical main body portion 910 while being slid thereon. In this manner, the light path division portion 900 is detachably attached to the optical main body portion 910.

The casing 81D includes the plate spring 89. A contact portion 811 contacting the main body 2 is formed at the distal end in the insertion direction of the light path division portion 900. When the optical unit 8E is inserted into the main body 2, the contact portion 811 comes into contact with a wall surface on an illumination side of an arm portion 2c, and a latch claw 89a included in the plate spring 89 engages with a click step portion 211a (refer to FIG. 6). The optical unit 8E thereby enters a state of being positioned in a direction retracting from the main body 2.

Furthermore, the light path division portion 900 includes the latch portion 812 and the spring member 813. With this configuration, also in the sixth embodiment, the optical unit 8E can be switched to a first position where the prism 820 is disposed on the observation light path Nb, and a second position where the prism 820 is retracted from the observation light path Nb. By switching the position of the optical unit 8E in this manner, in transmitted-light illumination observation performed using a light source 9, observation can be performed while switching whether to cause observation light to enter the image sensor 840.

When the optical unit 8E is removed from the main body 2, as described above, by pulling out the optical unit 8E in a state in which the latch portion 812 is pressed by inserting a bar member 100 from a hole portion 211d formed in the arm portion 2c, the optical unit 8E can be removed from the main body 2.

According to the sixth embodiment, similarly to the first embodiment, by switching an insertion position of the optical unit 8E with respect to the arm portion 2c, the image forming optical system is made insertable onto and removable from the observation light path Nb. Thus, an observation method, more specifically, observation using the observation portion 6A and observation using an image that is based on an electrical signal generated by the image sensor 840 can be switched without changes in positions of the observation portion 6A and an eyepiece 7 that are caused by the optical unit 8E. An optical element can be thereby easily inserted onto and removed from an observation light path while suppressing a change in eyepoint.

In addition, according to the sixth embodiment, similarly to the fifth embodiment, because the optical unit 8E includes the image forming optical system, an image of a specimen S can be acquired. If a focal length of the tube lens 830 is shortened without using a focal length common to the tube lens 63 of the observation portion 6A, the total length of the casing 81D can be shortened by using the image sensor 840 having a small size. Thus, a compact and easily-handled optical unit 8E can be provided. Furthermore, because a gravity center can be kept low even if the optical unit 8E is attached to the main body 2, safety is enhanced. Furthermore, because the entire height does not become high, storage easiness is enhanced.

In the sixth embodiment, any of a plurality of light path division portions 900 having prisms 820 with different light path division ratios that guide observation light toward both the observation portion 6A side and the optical main body portion 910 (image sensor 841) side can be attached. In other words, in the sixth embodiment, in the optical unit 8E, the light path division portion 900 can be replaced with a light path division portion 900 having a prism 820 with a light path division ratio suitable for observation. With this configuration, in the optical unit 8E, the replacement of a prism with a different light path division ratio can be easily performed.

In addition, in the sixth embodiment, the light path division portion 900 and the optical main body portion 910 are connected using the slide female dovetail 901 and the slide male dovetail 911. Alternatively, the light path division portion 900 and the optical main body portion 910 may be connected using a known connection method.

According to some embodiments, it is possible to easily insert and remove an optical element onto and from an observation light path while suppressing a change in height of a lens barrel.

Various embodiments can be formed by appropriately combining a plurality of elements disclosed in the above-mentioned embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microscope comprising:
a main body comprising: a base portion; a pillar portion vertically disposed on part of an outer edge portion of the base portion; and an arm portion extending from an end of the pillar portion to face the base portion, an opposite end of the pillar portion connecting to the base portion;
an objective lens support portion provided on one side of the arm portion facing the base portion, the objective lens support portion being configured to hold an objective lens that is detachable from the objective lens support portion;
an observation portion provided on an opposite side of the arm portion and configured to hold an eyepiece that is detachable from the observation portion; and
an optical unit configured to hold an optical element,
wherein the arm portion comprises a holding portion configured to hold the optical unit and locate the optical unit at a position intersecting with an optical axis of the objective lens held by the objective lens support portion.

2. The microscope according to claim 1, further comprising a stage which is supported on the main body and on which a specimen is configured to be placed,
wherein the optical unit comprises an epi-illumination optical system including the optical element and configured to irradiate the specimen with illumination light via the objective lens held by the objective lens support portion, and
when the optical unit is located at the position intersecting with the optical axis of the objective lens held by the objective lens support portion, an illumination light path of the epi-illumination optical system connects to the optical axis of the objective lens.

3. The microscope according to claim 2, wherein
the illumination light path of the epi-illumination optical system corresponds to one of a first position where the illumination light path connects to an observation light path passing through the objective lens held by the objective lens support portion and a second position where the illumination light path is deviated from the observation light path.

4. The microscope according to claim 3, wherein
the optical unit comprises:
an optical holding portion configured to hold the epi-illumination optical system; and
a grip portion provided on a proximal end side of the optical holding portion in a direction of inserting the optical unit into the holding portion, and configured to be gripped by a user when switching between the first and second positions.

5. The microscope according to claim 4, wherein
when the optical unit is housed in the holding portion, the grip portion is located in a space connecting to the holding portion.

6. The microscope according to claim 5, wherein
the arm portion further comprises a wall portion extending in a direction opposite to an extending direction of the arm portion to form the space.

7. The microscope according to claim 1, wherein
the holding portion has an opening through which the optical unit is configured to be inserted into the holding portion, and
a plane passing through the opening and being parallel to the optical axis of the objective lens held by the objective lens support portion is located between the pillar portion and the observation portion.

8. The microscope according to claim 1, further comprising a regulating mechanism configured to regulate removal of the optical unit from the holding portion.

9. The microscope according to claim 2, wherein the optical element is a light path dividing mirror.

10. The microscope according to claim 9, wherein
the epi-illumination optical system comprises:
a light source configured to emit light;
a collector lens configured to collect the light emitted by the light source;
an excitation filter configured to pass, among the light passed through the collector lens, light of a predetermined wavelength band to excite the specimen;
a dichroic mirror being the light path dividing mirror configured to reflect the light passed through the excitation filter and to pass the light from the specimen; and
an absorption filter configured to pass light of a specific wavelength band, among the light passed through the dichroic mirror.

11. The microscope according to claim 1, further comprising:
a stage which is supported on the main body and on which a specimen is configured to be placed; and
a transmitted-light illumination optical system provided within the base portion and configured to generate transmission illumination light to pass through the specimen,
wherein the optical unit comprises an image forming optical system including the optical element and configured to form a specimen image based on observation light entered the image forming optical system via the objective lens, and
when the optical unit is located at the position intersecting with the optical axis of the objective lens held by the objective lens support portion, an illumination light path of the image forming optical system connects to the optical axis of the objective lens.

12. The microscope according to claim 11, wherein
the illumination light path of the image forming optical system corresponds to one of a first position where the illumination light path connects to an observation light path passing through the objective lens held by the objective lens support portion and a second position where the illumination light path is deviated from the observation light path.

13. An optical unit used for a microscope,
the microscope comprising:
a main body comprising: a base portion; a pillar portion vertically disposed on part of an outer edge portion of the base portion; and an arm portion extending from an end of the pillar portion to face the base portion, an opposite end of the pillar portion connecting to the base portion;
an objective lens support portion provided on one side of the arm portion facing the base portion, the objective lens support portion being configured to hold an objective lens that is detachable from the objective lens support portion; and
an observation portion provided on an opposite side of the arm portion and configured to hold an eyepiece that is detachable from the observation portion,
the arm portion comprising a holding portion configured to house the optical unit and locate the optical unit at a position intersecting with an optical axis of the objective lens held by the objective lens support portion,
the optical unit comprising:
an optical element configured to be inserted onto a light path passing through the optical axis of the objective lens held by the objective lens support portion.

14. The optical unit according to claim 13, further comprising:
a light source configured to emit light;
a collector lens configured to collect the light emitted by the light source;
an excitation filter configured to pass, among the light passed through the collector lens, light of a predetermined wavelength band to excite a specimen;
a dichroic mirror configured to reflect the light passed through the excitation filter and to pass the light from the specimen; and
an absorption filter being the optical element configured to pass light of a specific wavelength band, among the light passed through the dichroic mirror.

15. The optical unit according to claim 13, wherein
the optical element is a light path changing member configured to change a traveling direction of observation light from a specimen after the observation light passes through the objective lens, and
the optical unit further comprises a tube lens provided on a light path of the observation light after the traveling direction is changed by the light path changing member, and configured to collect the observation light traveling along the light path to form an image at a predetermined position.

16. The optical unit according to claim 15, further comprising an image sensor provided at the predetermined position and configured to receive the observation light passed through the tube lens to perform photoelectric conversion on the observation light.

17. The optical unit according to claim 15, further comprising:
an optical main body portion configured to hold the tube lens; and
a light path changing unit attachable to and detachable from the optical main body portion and configured to hold the light path changing member.
